(19) United States
(12) Patent Application Publication
(10) Pub. No.: US 2021/0369053 A1
(43) Pub. Date: Dec. 2, 2021

(54) COOKING APPARATUS AND METHOD

(71) Applicant: Chad A. Grand, Baton Rouge, LA (US)

(72) Inventor: Chad A. Grand, Baton Rouge, LA (US)

(21) Appl. No.: 17/194,281

(22) Filed: Mar. 7, 2021

Related U.S. Application Data
(60) Provisional application No. 62/986,694, filed on Mar. 7, 2020.

(51) Int. Cl. A47J 37/07; A47J 37/06; F24C 15/30

(52) U.S. Cl. CPC A47J 37/0713; A47J 37/0682; A47J 2037/0777; A47J 37/0664; F24C 15/30; A47J 37/0647

(57) ABSTRACT

Disclosed herein is a cooking apparatus having a cooking heat source; a grill grate having a grill grate surface, the grill grate being positioned over the cooking heat source; a griddle plate, the griddle plate being moveable between a cooking position and a stowed position, the griddle plate being positioned over the grill grate in the cooking position, and the griddle plate being lower than the plane of the grill grate surface in the stowed position; a counterbalance mechanism connected to the griddle plate; a support frame with a slot extending vertically through the support frame, and a lid, the lid having an open position and a closed position, with a portion of the lid extending through the slot when the lid is in the open position, and with the portion of the lid not extending through the slot when the lid is in the closed position.

### CROSS-REFERENCE TO RELATED APPLICATION

This application claims the benefit of U.S. Provisional Application No. 62/986,694, filed Mar. 7, 2020, which is hereby incorporated by reference in its entirety.

### BACKGROUND

Cooking apparatuses, such as a grill, can be used to cook food. A grill typically includes or is provided with one or more cooking heat sources that are intended to and/or used to cook food. The cooking heat source can be provided by burning gas (such as propane or natural gas), charcoal, wood, or other materials, or can be powered by electricity or other sources of heat. Grills can be intended for use indoors or outside. Conventional outdoor gas, charcoal or wood grills typically include at least one cooking surface, and in many models the cooking surface is a grill grate that is positioned above (i.e. with respect to the Earth's surface and the direction of gravity) one or more cooking heat sources. For example, in a typical outdoor gas grill, gas powered burners are positioned below a grill grate, and the burners provide a source of heat that is used to cook food items that are placed on the grill grate. Burners for grills can include rotisserie burners, infrared burners, or other types of burners.

### BRIEF DESCRIPTION OF THE SEVERAL VIEWS OF THE DRAWINGS

FIGS. 1 through 8 depict an embodiment of cooking apparatus described herein, with a cooking surface being moved between a cooking position and a stowed position.

FIGS. 9 through 25 depict another embodiment of cooking apparatus described herein, with a moveable cooking surface and a moveable lid.

FIG. 26 depicts an embodiment of a grill grate.

FIGS. 27 depicts an embodiment of a movement mechanism described here.

FIGS. 28 through 33 depict another embodiment described herein, with a moveable cooking surface and a moveable lid.

FIG. 34 depicts an embodiment of a mechanism described here.

FIGS. 35 through 63 depict embodiments described herein.

FIGS. 64 through 67 depict embodiments of a lid described herein.

### DETAILED DESCRIPTION

As required, detailed embodiments of the present invention are disclosed herein. However, it is to be understood that the disclosed embodiments are merely exemplary of the invention, which can be embodied in various forms. As such, any feature(s) used in one embodiment can be used in another embodiment. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “connected” and/or “coupled,” as used herein, are defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

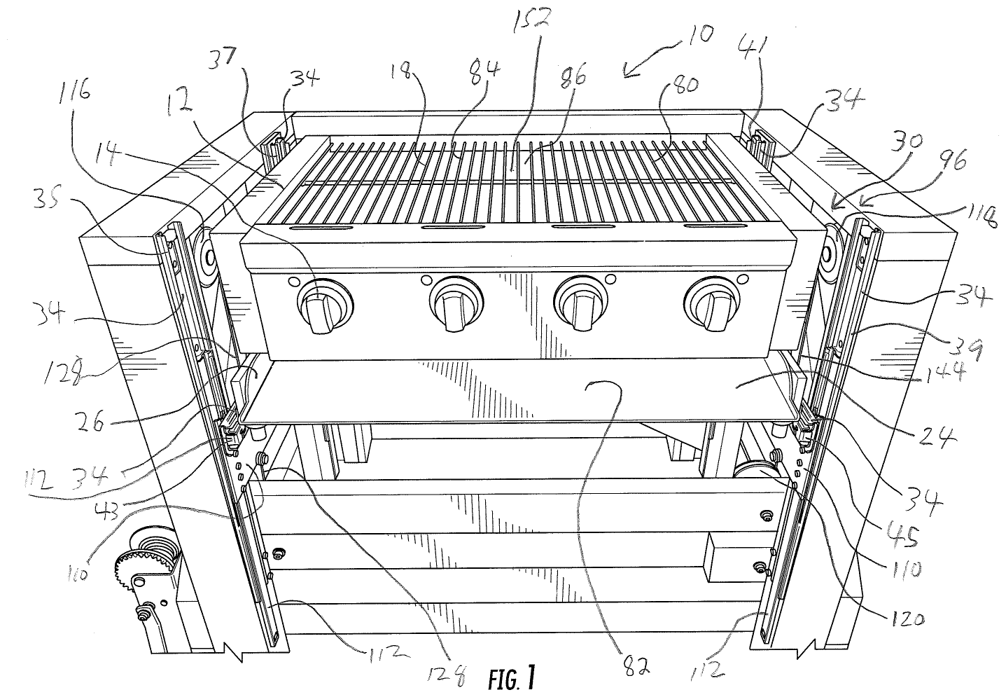

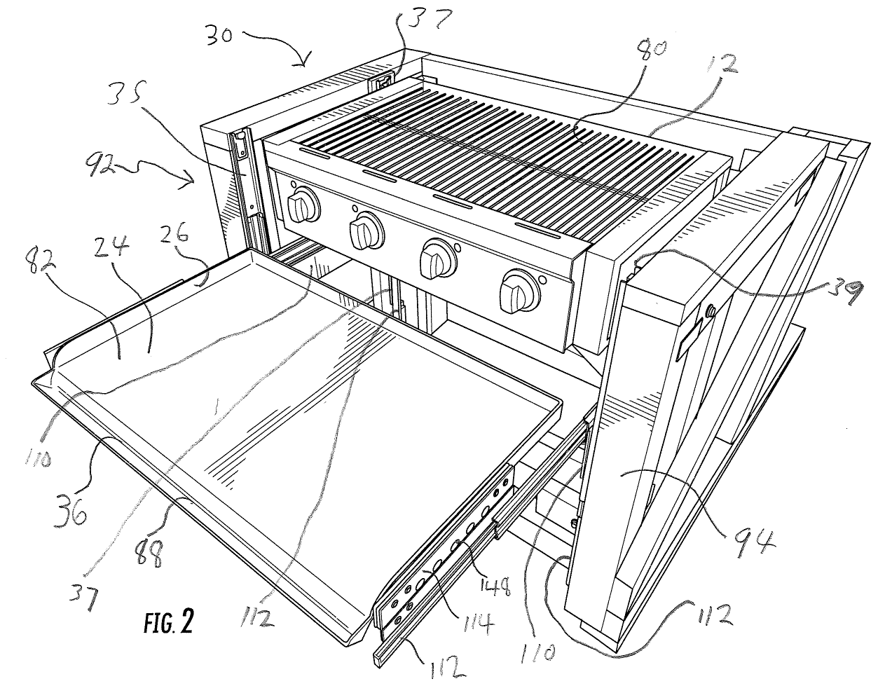

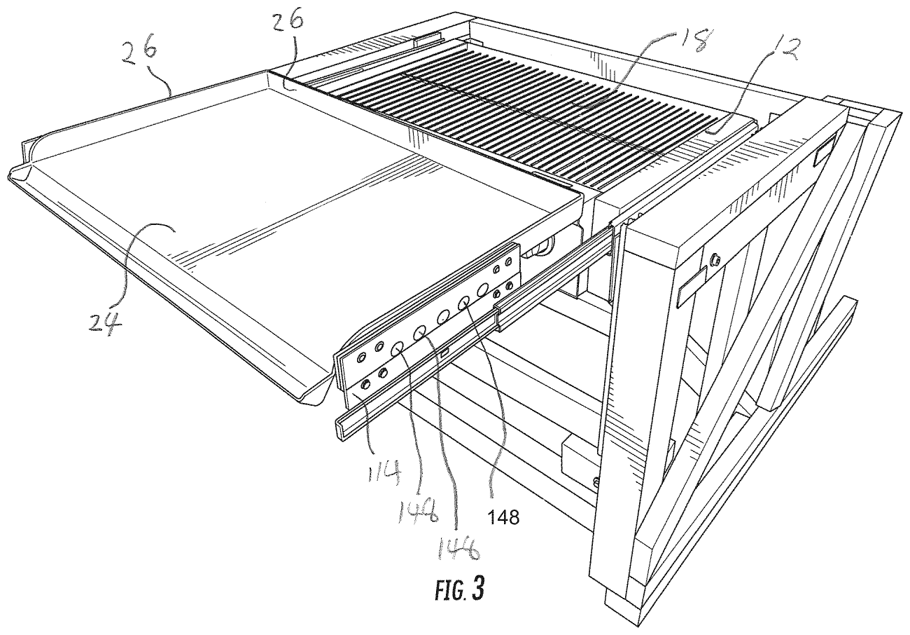

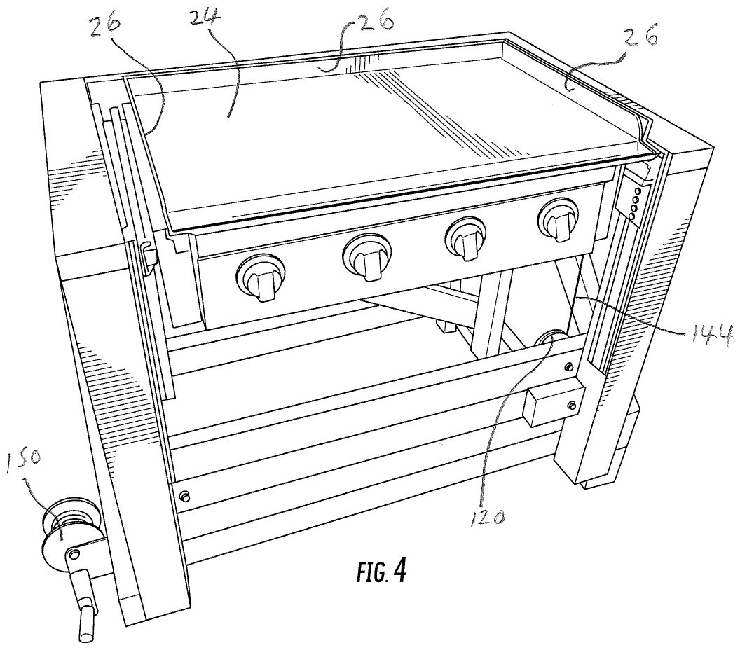

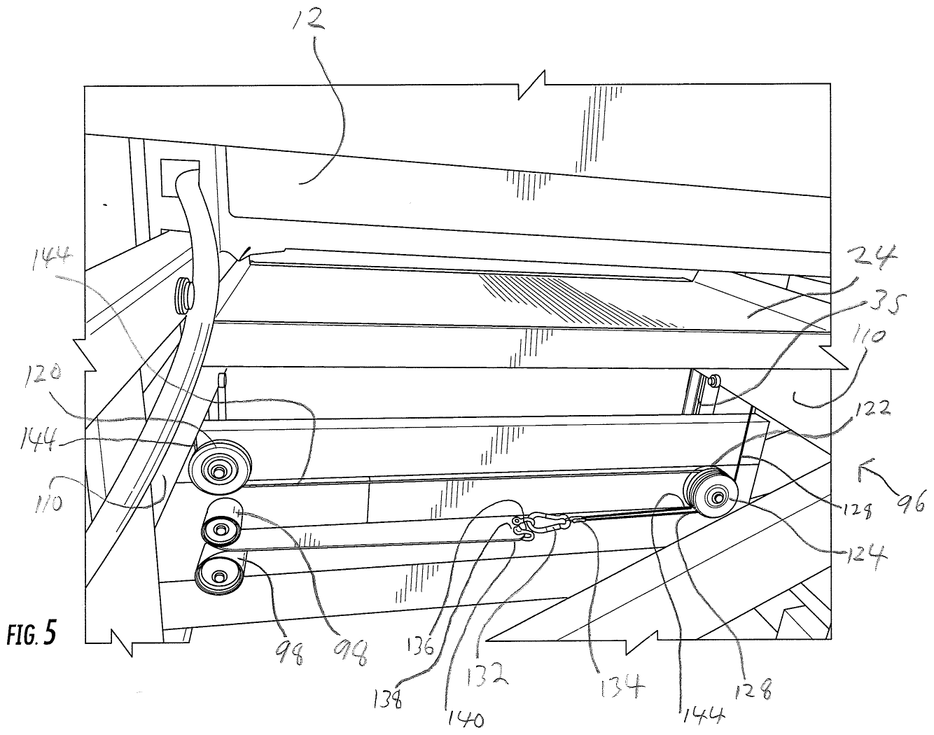

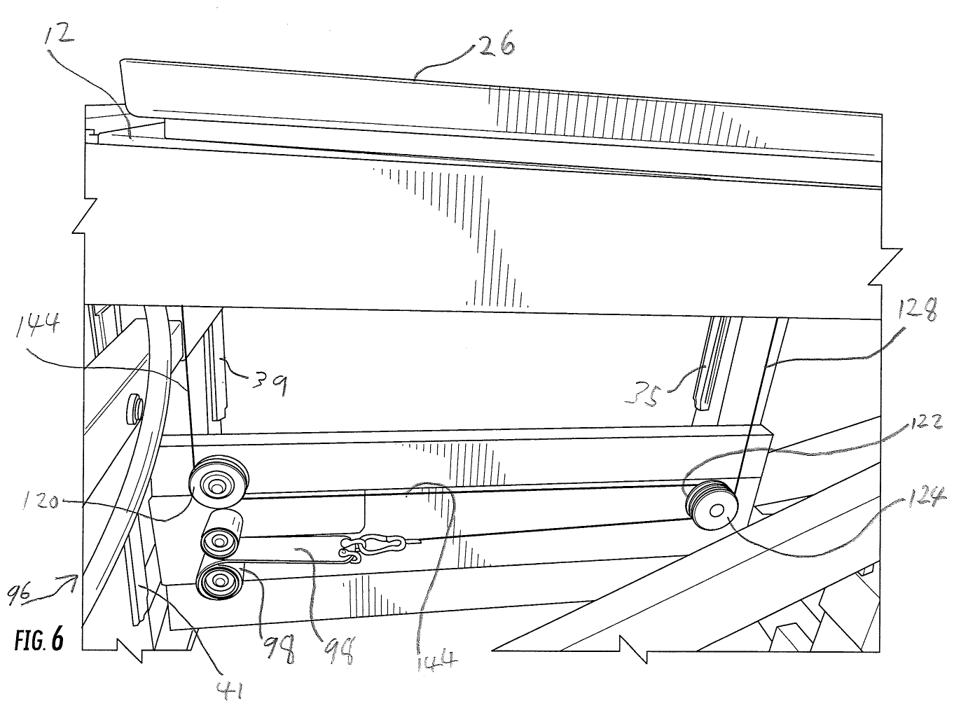

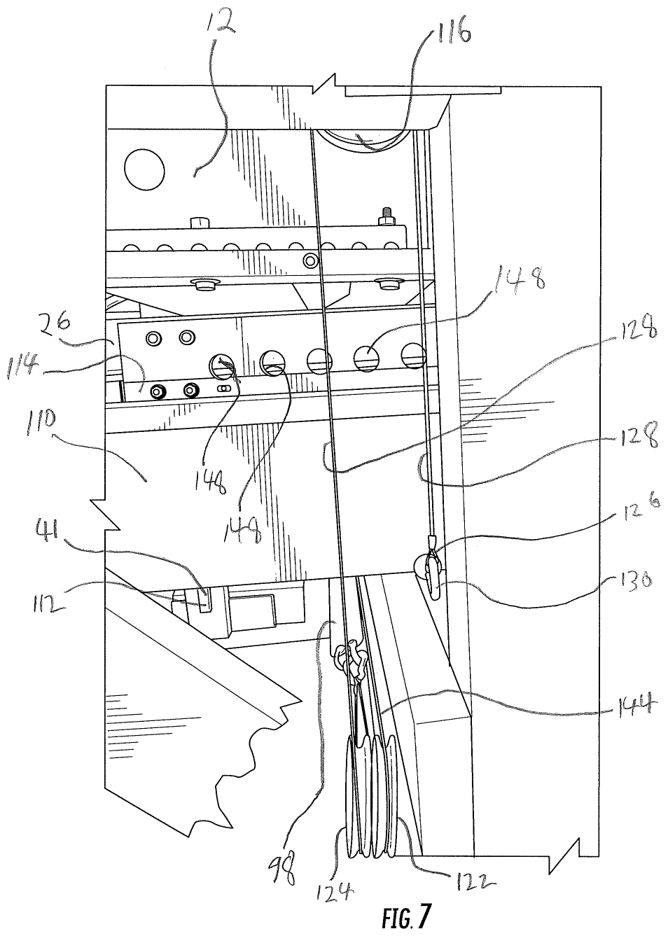

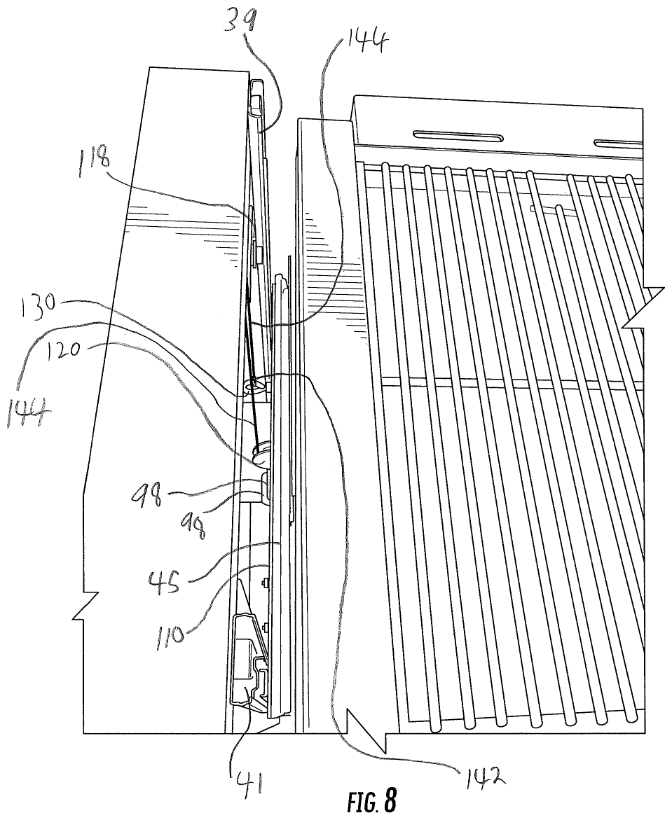

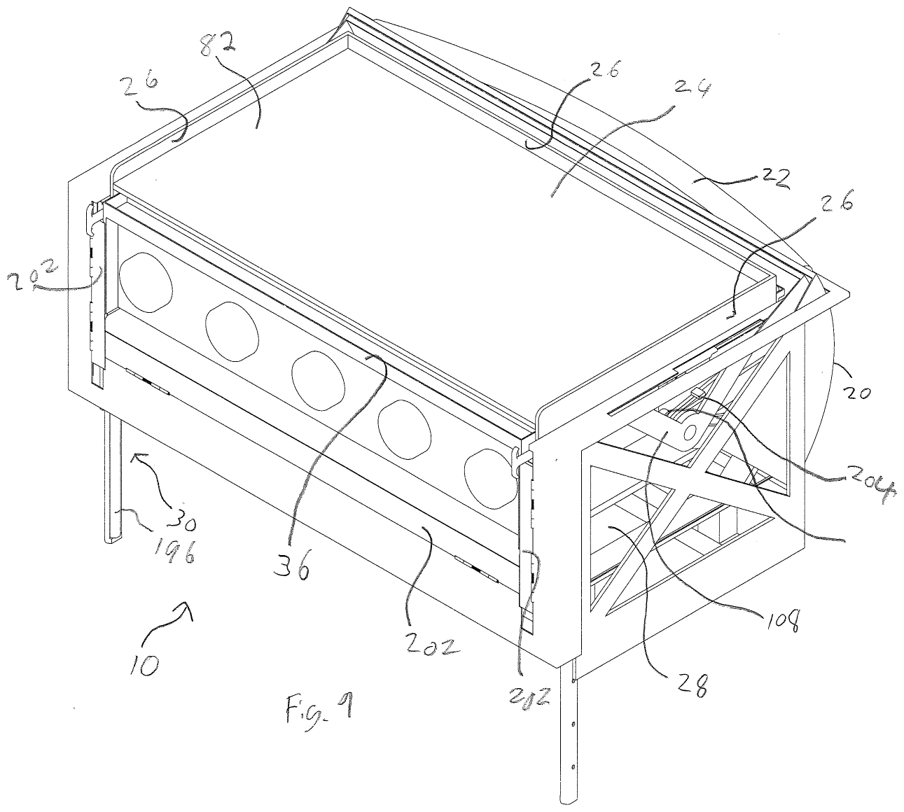

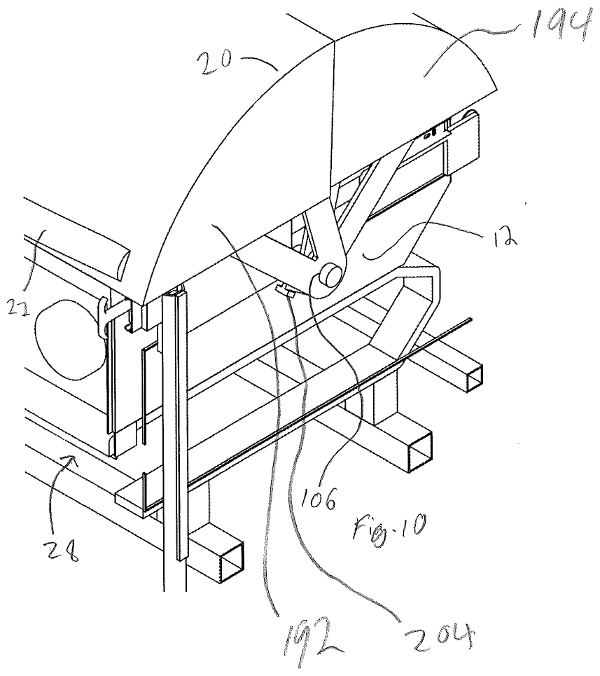

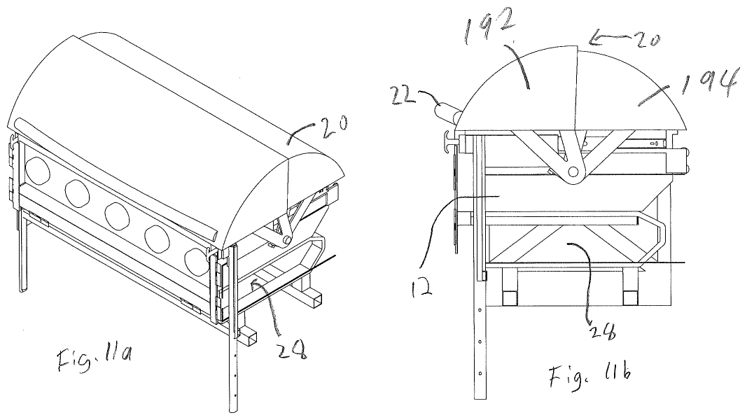

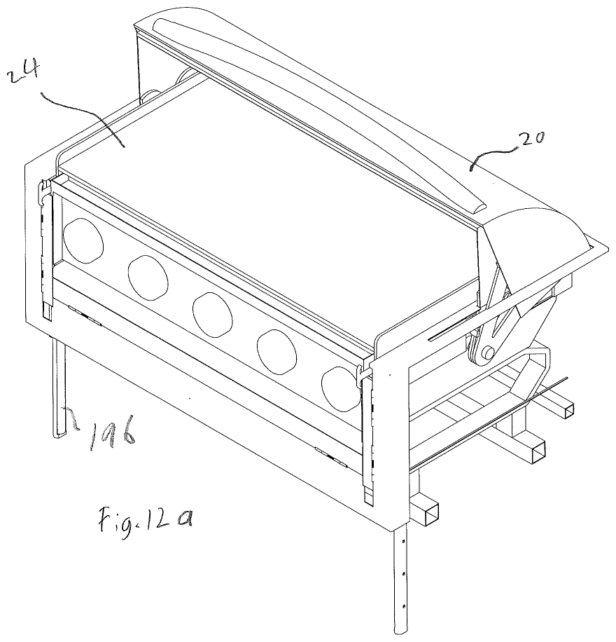

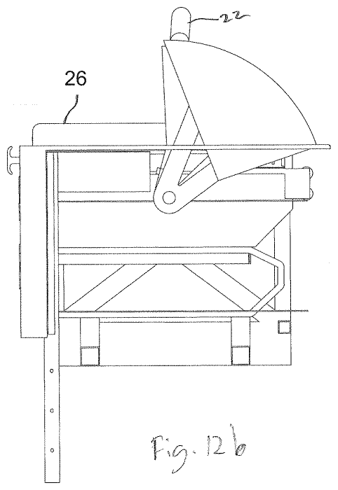

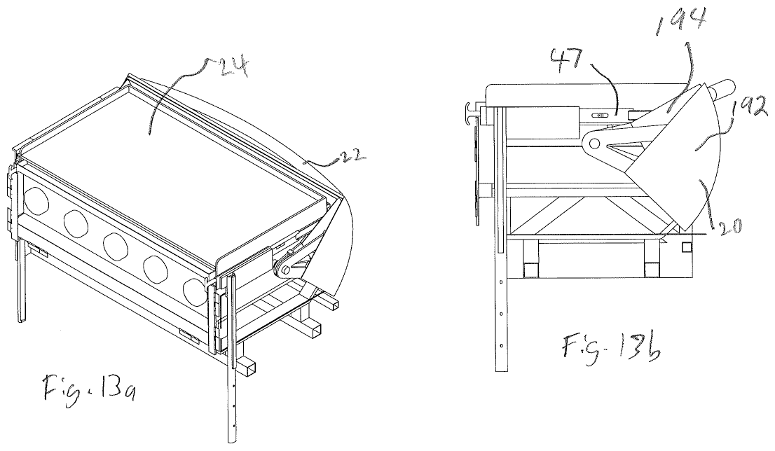

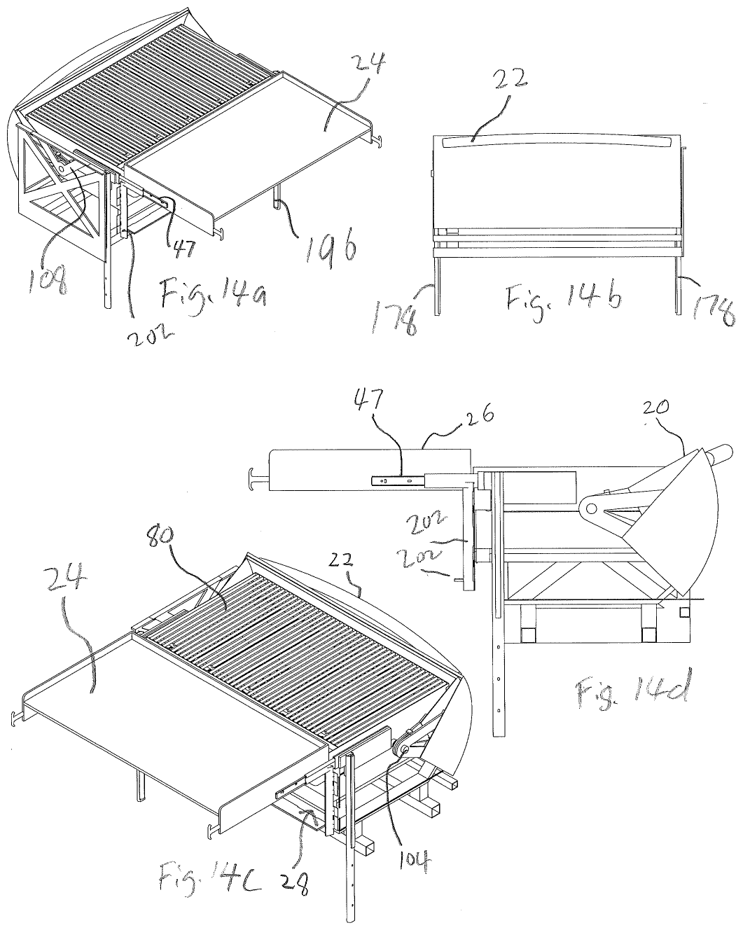

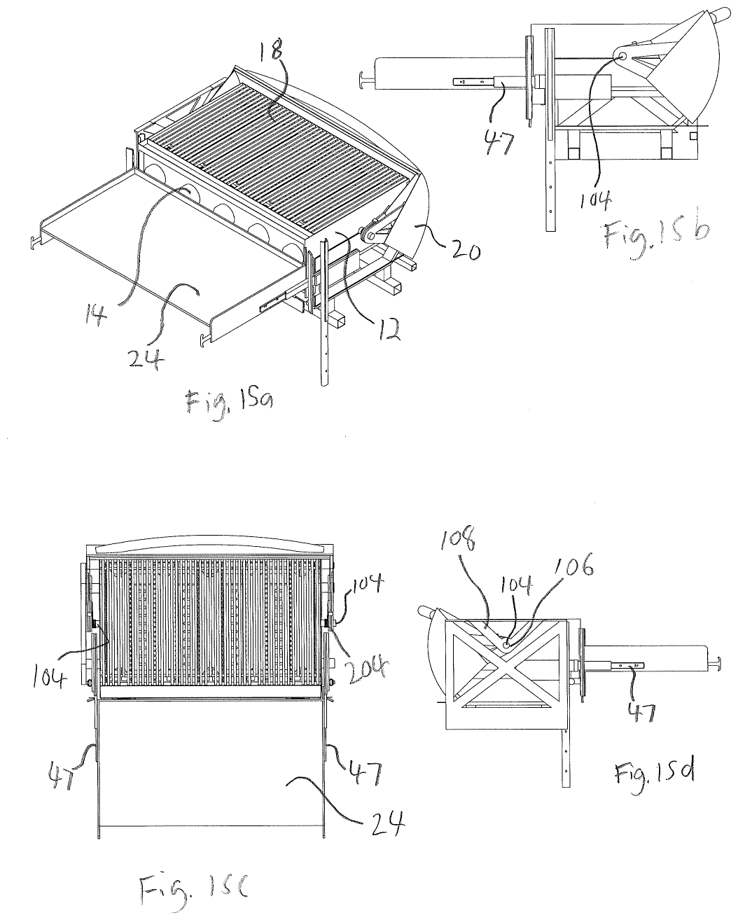

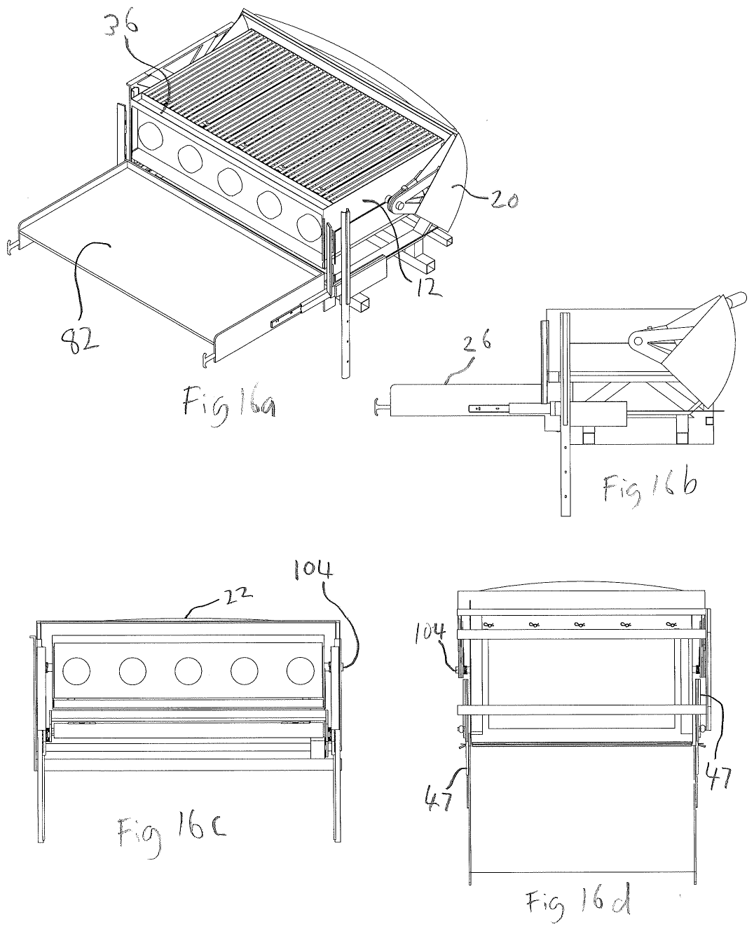

Described now are exemplary embodiments of the present invention. Referring now to the drawings, an exemplary embodiment of a cooking apparatus 10 is shown. In an embodiment, the cooking apparatus includes a grill body 12, for example the type of grill body that is used in connection with outdoor gas grills. The cooking apparatus can include control knobs 14, which can be used for controlling the intensity of heat provided by a cooking heat source, such as burners 16. The cooking apparatus can include one or more grill grates 18. A grill grate 18 is shown, for example, in FIGS. 1, 23a and 26. The grill grate 18 is shown in isolation in FIG. 26. FIG. 23a is a top view, and in this embodiment only the rear portion of the grill grate 18 is visible.

In some embodiments, as shown for example in FIGS. 9 to 22 and 28 to 31, the cooking apparatus 10 can include a lid 20, which can be moved between an open position and a closed position. The lid 20 is shown in an open position in, for example, FIGS. 9, 13a, 13b, 21, 22, and 28a to 28d, and in a closed position in FIGS. 10, 11a, 11b, 19a, 19b, and 20a to 20g. The lid can include a handle 22.

In an embodiment, the cooking apparatus 10 can include a griddle, which can include a griddle plate 24. The griddle can include sides 26, which can be used to retain food items on the griddle plate 24. A griddle storage slot 28 can be provided, and can be used to house the griddle plate 24 when the griddle plate 24 is in a stowed position. The griddle plate 24 is depicted in a stowed position in, for example, FIGS. 1, 5, 7, 17 to 19, 21, 24a, 24b, 28a, 28b, 28c, 28d.

In an embodiment, the cooking apparatus 10 can include a lift mechanism 30, which can include a lift mechanism support structure 32. One or more extendable rails, such as slides 34, can be connected to the griddle plate 24. The slide 34 can also be connected to the lift mechanism 30, such that the slide 34 interconnects the griddle plate 24 and the lift mechanism 30. In an embodiment, the cooking apparatus 10 can include a grease trap or grease tray 36.

An embodiment can include a first cooking surface 80 and a second cooking surface 82. In an embodiment the first cooking surface can be a grill grate 18. In an embodiment, the grill grate can include a series of rods 84 (e.g. ribs, bar, or the like), with a series of openings 86, such as gaps, spaces or holes, between or in the series of rods 84. The series of openings can allow radiant heat, hot air, combustion gases, smoke, flames, etc. to pass through the grill grate 18. In an embodiment, the grill grate 18 can be made of metal, such as steel, stainless steel, A36 steel, carbon steel, aluminum, iron, cast iron, copper, brass, bronze, or other metals. Instead of or in addition to metal, the grill grate 18 can be made of materials such as ceramic, porcelain, or other materials.

In an embodiment, the second cooking surface 82 can be a griddle plate 24. In an embodiment, the griddle plate 24 can be a substantially flat and substantially contiguous surface on which food items are intended to be cooked. In an embodiment, the griddle plate 24 is a flat plate that has a thickness of between about 0.125 inches (3.175 millimeters) and about 1 inch (25.4 millimeters), a width (left to right) of between about 15 inches (381 millimeters) and about 75 inches (1,905 millimeters), and a depth (front to back) of between about 10 inches (254 millimeters) and about 40 inches (1,016 millimeters). In an embodiment the griddle plate 24 is a flat plate that is 0.375 inches (9.525 millimeters) thick, and has a width of 37 inches (939.8 millimeters) and a depth of 20 inches (508 millimeters). In an embodiment, the griddle plate 24 has a width that is at least 1.5 times its depth. In an embodiment, the griddle plate 24 has a weight of between about 40 pounds (18.1437 kilograms) and about 150 pounds (68.0389 kilograms). An embodiment of the griddle plate 24 has a weight of about 90 pounds (40.8233 kilograms). In an embodiment, the griddle plate 24 can be made of metal, such as steel, stainless steel, A36 steel, carbon steel, aluminum, iron, cast iron, copper, brass, bronze, or other metals. Instead of or in addition to metal, the griddle plate 24 can be made of materials such as ceramic, porcelain, or other materials. In an embodiment, the griddle plate 24 can be a core of aluminum laminated with type 304 stainless steel on all sides. Such an embodiment can have the benefit of the low weight and high heat transfer rate of aluminum, while also benefiting from the high corrosion resistance and low level of porosity of type 304 stainless steel.

In an embodiment, the griddle plate 24 can have one or more holes through the griddle surface, for example to allow grease or debris to drain off of the griddle surface and into a grease tray. In an embodiment the griddle plate can have one or more channels, for example a channel along one or more of the outer edges of the griddle plate, for collecting grease or debris that drains from the griddle plate 24. In an embodiment, a channel 88 can extend along the length of the front edge of the griddle plate 24, and can have one or more holes through the bottom of the channel to allow grease or other debris to drain from the channel and into a grease collection or storage receptacle.

In an embodiment, the cooking apparatus 10 is a grill that can be modified, or converted, between a configuration in which food items are cooked on or intended to be cooked on a grill grate 18, and a configuration in which food items are cooked on or intended to be cooked on a griddle plate 24. In an embodiment, this can be accomplished by positioning a grill grate 18 over a cooking heat source 90. A griddle plate 24 can then be provided which is moveable between a position over the grill grate 18 (e.g. FIG. 23a) and over the cooking heat source (thus making the griddle plate 24 available for cooking over the cooking heat source), and a position that is not over or primarily not over the grill grate 18 and cooking heat source 90 (thus making the grill grate available for cooking over the cooking heat source), such as a stowed position (e.g. FIG. 24a, 24b). An arm, which can include a lift mechanism 30 and/or a slide 34, can be provided and can support some of or all of the weight of the griddle plate 24 when the griddle plate 24 is moved between a cooking position and a stowed position.

In an embodiment, the griddle plate 24 is connected to a mechanical (i.e. non-human) arm 92. In an embodiment, the mechanical arm 92 connects the griddle plate to a support structure 94. In an embodiment, the mechanical arm 92 can include a lift mechanism 30. The lift mechanism can include a counterbalance mechanism 96 that can support all of or substantially all of the weight of the griddle plate 24, by exerting an upward force on the griddle plate 24 that acts against the downward force of the griddle plate 24 due to gravity. Such a counterbalance mechanism can allow the griddle plate 24 to be balanced in a substantially neutral position relative to the vertical, such that even a slight additional force applied to the griddle plate 24 in an upward or downward direction, for example by a user, will cause the griddle plate 24 to move upward or downward respectively.

In an embodiment, the lift mechanism 30 can be configured such that if movement of the griddle plate 24 is stopped at any point or substantially any point during movement of the griddle plate 24 between the cooking position and the stowed position, the griddle plate 24 will remain stationary until an additional force is applied to it. For example, in an embodiment in which there is a vertical movement component to some of or all of the griddle plate 24 during movement of the griddle plate 24 between a cooking position and a stowed position, a counterbalance mechanism 96 and the force provided by the counterbalance mechanism 96 can be configured such that if the vertical movement of the griddle plate 24 is stopped at any point or at substantially any point during the vertical movement that occurs during the movement of the griddle plate 24 between a cooking position and a stowed position, the griddle plate 24 will remain stationary until it is manually moved (e.g. by a user) to another position.

In an embodiment, a counterbalance mechanism can include a device, system, etc., that provides a weight or force that balances or offsets the weight of the griddle plate during vertical movement of all of or a portion of the griddle plate. In an embodiment, the counterbalance mechanism can be designed and/or configured so that the force provided by the counterbalance mechanism varies in a desirable way. For example, a counterbalance mechanism can be designed and/or configured such that the upward force exerted by the counterbalance mechanism is reduced as the griddle plate approaches a fully lowered position, and such that the upward force exerted by the counterbalance mechanism is increased as the griddle plate approaches a fully raised position. In such an embodiment, when in the fully raised position the griddle plate is biased towards the fully raised position, and when in the fully lowered position the griddle plate is biased towards the fully lowered position.

In an embodiment, a counterbalance mechanism can be designed and/or configured such that the counterbalancing force of the counterbalance mechanism matches the opposing force of the griddle plate through the range of motion of the griddle plate. In some embodiments, this can mean the counterbalancing force remains constant through the range of motion of the griddle plate (e.g. in instances where the opposing force of the griddle plate remains constant through the range of motion of the griddle plate). In other embodiments, this can mean the counterbalancing force varies through the range of motion of the griddle plate (e.g. in instances where the opposing force of the griddle plate varies through the range of motion of the griddle plate, the counterbalancing force of the counterbalance mechanism can vary proportionally).

In an embodiment, a counterbalance mechanism can be design or configured such that the counterbalancing force exerted by the counterbalance mechanism on the griddle plate remains relatively constant as the griddle plate is moved vertically. For example, in the embodiments shown in FIGS. 1-8, the counterbalance mechanism 96 uses constant force springs 98 to provide a relatively constant counterbalancing force for the griddle plate 24 during the vertical movement of the griddle plate 24 between the cooking position and the stowed position. As another example, in the embodiments shown in FIGS. 28 to 32 and 34, the counterbalance mechanism 100 uses a compression spring 101 in conjunction with lever arms 102 to provide a relatively constant counterbalancing force for the griddle plate 24 as the counterbalance mechanism 100 moves the griddle plate 24 vertically (e.g. up and down).

A constant force spring, such as the two constant force springs 98 utilized in the counterbalance mechanism of the embodiments depicted in FIGS. 1 to 8, is a type of spring for which the force it exerts over its range of motion is relatively constant.

Constant force springs are typically constructed as a rolled ribbon of spring steel such that the spring is in a rolled up form when relaxed, and such that the spring unrolls when the spring is subjected to a sufficient load. An example of a constant force spring is part number SH31U60 produced by Vulcan Spring & Manufacturing Co. In some embodiments, rather than a constant force spring, other types of springs or force producing devices can be used to provide a counterbalancing force for the griddle plate or other object. For example, helical tension springs or compression springs can be used. Many springs, such as helical tension springs and compression springs, obey a principle of physics knows as Hook's law. Hooke's law states that the force (F) needed to extend or compress a spring by some distance x scales linearly with respect to that distance. That is: F=kx, where k is a constant factor characteristic of the spring: its stiffness, and x is small compared to the total possible deformation of the spring. Thus, for extension springs that obey Hook's law, as the extension of an extension spring increases, the force exerted by the extension spring increases linearly with its extension.

In some embodiments, it can be desirable to manipulate the force exerted by a spring of a counterbalance mechanism so that the counterbalance mechanism provides a desirable counterbalancing force throughout the range of motion of an object (e.g. a griddle plate, a lid or lid portion of a grill, etc.) connected to the counterbalance mechanism. For example, in embodiments in which a counterbalance mechanism utilizes a spring that obeys Hook's law to provide the counterbalancing force, but in which it is desired that the counterbalance mechanism provide a relatively constant counterbalancing force during some or all of the movement of an object (e.g. a griddle plate) connected to the counterbalance mechanism, the counterbalance mechanism can be designed and/or configured so that the linearly increasing force exerted by the spring is converted into a relatively constant counterbalancing force. For example in embodiments of a counterbalance mechanism in which helical tension springs or compression springs are used, a cam, lever arm, or other structure or method can be used to manipulate the force exerted by the spring so that the counterbalance mechanism provides a relatively constant counterbalancing force during motion of a griddle plate (or other object). For example in embodiments in which a tension spring is used, a snail cam pulley can operate in conjunction with the tension spring to provide a relatively constant counterbalancing force.

In such an embodiment, a snail cam pulley can include a snail cam wheel secured to a mount by an axle, with the axle defining an axis of rotation for the snail cam wheel. The snail cam wheel can have a cam track and a lift track. The cam track can have a variable radius relative to the axis of rotation of the cam wheel. One end of a tension spring can be secured to a mounting point, and a snail cable can connect the other end of the tension spring to the cam track of the snail cam wheel, while a lift cable can connect an object which is to be counterbalanced (e.g. a griddle plate) to the lift track of the snail cam wheel. Due to the variable radius of the cam track, the cam track can function as a variable lever arm by which the spring force is applied to the snail cam wheel. In such an embodiment, the radius of the cam track can be varied so that as the snail cam wheel rotates the effective lever arm decreases. In such an arrangement, the linearly increasing force exerted by the tension spring can be converted into a relatively constant force as the snail cam wheel rotates and the snail cable wraps around the cam track.

A cam, lever arm, and/or other structure or method can be used to manipulate the force exerted by any of the springs or force inducing mechanisms described herein, including but not limited to helical springs, gas springs, constant force springs, etc. For example, a cam pulley, lever arm(s), or other structures or methods can be used to vary the effective force exerted by a spring or force inducing means in a desirable manner.

For example, in an embodiment of a counterbalance mechanism for a griddle plate that assists in the movement of a griddle plate between a raised position and a lowered position, the force exerted by a spring of the counterbalance mechanism can be manipulated so that it results in the counterbalance mechanism: a) providing a relatively constant counterbalancing force (e.g. 90 pounds or 40.8233 kilograms) in the middle positions of the vertical travel path of the griddle plate; b) providing an increased counterbalancing force (e.g. 93 pounds or 42.1841 kilograms) towards the raised position of the vertical travel path of the griddle plate; and c) providing a decreased counterbalancing force (e.g. 87 pounds or 39.4625 kilograms) towards the lowered position of the vertical travel path of the griddle plate. In such an embodiment, as the griddle plate moves towards the raised position, the increasing force exerted by the spring can facilitate the griddle plate's movement to the fully raised position, and then bias the griddle plate in the fully raised position until a sufficient downward force is applied. Similarly, as the griddle plate moves towards the lowered position, the decreasing force exerted by the spring can facilitate the griddle plate's movement to the fully lowered position, and then bias the griddle plate in the fully lowered position until a sufficient upward force is applied. Such a counterbalance mechanism can allow a relatively heavy griddle plate (e.g. 90 pounds or 40.8233 kilograms) to have natural resting positions at the fully raised and at the fully lowered positions, while also allowing a user to move the griddle plate between the fully raised and fully lowered positions with relatively little effort.

In an embodiment, extendable rails can be utilized, and can be slidably engaged (either directly or indirectly) with a griddle plate (or other object). One or more extendable rails can, for example, facilitate and/or guide movement of the griddle plate, such as horizontal or vertical movement of the griddle plate. In an embodiment, a mechanical arm, a lift mechanism, and/or a counterbalance mechanism can include one or more extendable rails.

In an embodiment, extendable rails can include, but is not limited to items such as slides, drawer slides, telescoping slides, ball bearing carriages and corresponding guide rails, roller bearing carriages and corresponding guide rails, track roller carriages and corresponding guide rails, gliding surface carriages and corresponding guide rails, and the like. In an embodiment, extendable rails can include one or more linear motion solutions, such as those produced by PBC Linear.

In an embodiment an extendable rail can be a telescopic ball bearing slide, and can be made of materials such as steel, stainless steel, aluminum, plastic, and/or other materials. The slide can be lubricated with food-grade and high temperature grease. The slide can be an over travel slide, such that the extension portion of the slide when the slide is in the extended position extends beyond the length of the slide that the slide has when the slide is in the non-extended position. The slide can have between approximately one and two inches (25.4 and 50.8 millimeters) of over travel, and can have a hold-in detent and/or hold-out detent, and/or a lock-in detent and/or a lock-out detent. The slide can be configured such that the lock-out detent is engaged when the griddle plate is in intermediate positions relative to the vertical, and such that the lock-out detent is disengaged when the griddle plate is in either the raised position or the lowered position relative to the vertical. In an embodiment, such as the embodiments depicted in FIGS. 1 to 20 and 27, such an arrangement can prevent the griddle plate 24 from being moved toward the retracted position (a griddle plate 24 is shown in a retracted position in FIGS. 11a and 11b, and FIGS. 17a and 17b) when the griddle plate 24 is in an intermediate position relative to the vertical (the griddle plate 24 is in an intermediate position relative to the vertical in FIGS. 15a to 15d), but will allow the griddle plate to be moved toward and into the retracted position when the griddle plate is in either the raised position (FIGS. 14a to 14d) or the lowered position (FIGS. 16a to 16d) relative to the vertical. Such an arrangement can prevent the griddle plate from possibly damaging the grill knobs 14, grill body 12, and other structures if the griddle plate 24 were moved toward the retracted position when the griddle plate 24 is in an intermediate position relative to the vertical.

In an embodiment, a slide can be a Accuride model SS5321-20, which is a stainless steel slide with a 19.68 inch (500 millimeter) slide length, 20.61 inches (523.5 millimeters) of travel, and a load rating of 352 pounds (160 kilograms). In an embodiment, the slide can be a Sugastune model ESR-7-20, which is a 304 grade stainless steel slide with a 20 inch (508 millimeter) slide length, 21.22 inches (539.2 millimeters) of travel, and a load rating of 106 pounds (49 kilograms).

In an embodiment, two way slides, such as Accuride model 0363 slides, may be utilized. In the embodiments depicted in FIGS. 9 to 20, two way slides 47 are utilized, with the griddle plate 24 in a cooking position corresponding to the slides 47 being fully extended in a direction towards the rear of the grill, and with the griddle plate 24 in a vertically moveable position corresponding to the slides 47 being fully extended in the opposite direction (i.e. towards the front of the grill). By doing so, when the griddle plate 24 is extended towards the front of the grill, the back end of the slides do not necessarily need to extend to the back end of the grill, and, for example, the back end of the slides 47 can extend only to approximately the half way point between the front of the grill and the back of the grill. By doing so, the options for supporting the weight of the grill are increased since the slides 47, when moved vertically, only slice through a plane extending from the front of the grill to the middle of the grill, rather than from the front of the grill all the way to the back of the grill. Thus, the weight of the grill can be supported from the sides at positions from the rear of the grill, up to the back end of the slides 47 when the slides are extended towards the front of the grill. For example, one such position can be the center of rotation about which the lid 20 pivots, which in some embodiments is at the center of curvature of the circular lid profile. Thus, the weight of the grill (and other components) can be partially or fully supported from the left and right sides of the grill, with e.g. weight supporting rods 104 attached to and extending from the grill body 12, through the respective lid pivots 106 (thereby also serving as the weight supporting member to which the lid is pivotally attached), and out to and attached to a support structure 108, for example an external support structure (such as a wheeled grill cart/cabinet, a counter of an outdoor kitchen, or other support structure). Such an arrangement can allow the weight of the grill to be supported, without interfering with the travel paths of either the lid 20, or the griddle plate 24 and its associated slides 47.

In an embodiment, full length one way slides can be used. In an embodiment, the front half of each slide is attached to the griddle plate, and a slot extends between each slide and the griddle plate along the back half of each slide, thereby allowing a support structure to, for example, extend down through the slots and connect to structure, such as the weight supporting rods.

Referring to the embodiment depicted in FIGS. 1 to 8, the cooking apparatus 10 can include a lift mechanism 30. In the embodiments depicted in FIGS. 1 to 8, the lift mechanism 30 is a counterbalance mechanism 96. As is shown in the Figures and as is described below, the counterbalance mechanism 96 is connected to the griddle plate 24. The counterbalance mechanism 96 includes six extendable rails, such as ball bearing slides 34. In the embodiment depicted in FIGS. 1 to 8, four of the slides 34 are oriented vertically, namely front left slide 35, rear left slide 37, front right slide 39, and rear right slide 41. Two of the slides are oriented horizontally, namely left horizontal slide 43 and right horizontal slide 45. Each of vertical slides 35, 37, 39, and 41 are secured to support structure 94.

A mounting plate 110 extends between vertical slides 35 and 37, and is secured to the extension portions 112 of slides 35 and 37. In the embodiment depicted in FIGS. 1 to 8, the mounting plate 110 is secured to what is typically considered to be the rear end of the extension portions 112 of slides 35 and 37. Similarly, another mounting plate 110 extends between vertical slides 39 and 41, and is secured to the extension portions 112 of slides 39 and 41. In the embodiment depicted in FIGS. 1 to 8, the mounting plate 110 is secured to what is typically considered to be the rear end of the extension portions 112 of slides 39 and 41.

The left horizontal slide 43 is secured to the top portion of left mounting plate 110, and the right horizontal slide 45 is secured to the top portion of right mounting plate 110. Quick change brackets 114 are secured to the extension portions 112 of the left and right horizontal slides 43 and 45. The left quick change bracket 114 is secured to the left side 26 of the griddle, which is in turn connected to the griddle plate 24. Similarly, the right quick change bracket 114 is secured to the right side 26 of the griddle, which is in turn connected to the griddle plate 24. The quick change brackets 114 provide a secure but releasable connection to the extension portions 112 of the slides 43 and 45, and therefore can allow a griddle plate 24 to be quickly and easily installed to or uninstalled from the slides 43 and 45.

One or more pulleys can be used to connect the griddle plate 24 to a force producing component of the lift mechanism 30, such as one or more springs. For example, one or more cables, such as a metal cable, a rope cable, or the like, can connect (either directly or indirectly) at one end to a griddle plate 24. The cable can then pass through one or more pulleys until the second end of the cable reaches and attaches to the force producing component (e.g. springs).

In the embodiment depicted in FIGS. 1 to 8, there are five pulleys, namely pulley 116, pulley 118, pulley 120, pulley 122, and pulley 124. A first end 126 of a first cable 128 is connected to an eyebolt 130, which is in turn connected to the left mounting plate 110. With this arrangement, the first end 126 of the first cable 128 is operatively connected to the left portion of the griddle plate 24. The first cable 128 starts where its first end 126 connects to eyebolt 130. From there, first cable 128 extends up to pulley 116. Next, cable 128 wraps around pulley 116, and then extends down to pulley 124. Cable 128 then wraps around pulley 124, and from there extends substantially horizontally over to a spring link 132 where a second end 134 of the first cable 128 connects to the spring link 132. Spring link 132 is in turn connected to shackle 136. Shackle 136 is then secured to both of the constant force springs 98, namely the end 138 of the first constant force spring, and the end 140 of the second constant force spring.

A first end 142 of a second cable 144 is connected to an eyebolt 130, which is in turn connected to the right mounting plate 110. With this arrangement, the first end 142 of the second cable 144 is operatively connected to the right portion of the griddle plate 24. The second cable 144 starts where its first end 142 connects to eyebolt 130. From there, second cable 144 extends up to pulley 118. Next, cable 144 wraps around pulley 118, and then extends down to pulley 120. Cable 144 then wraps around pulley 120, and from there extends substantially horizontally over to pulley 122. Next, cable 144 wraps around pulley 122, and from there extends substantially horizontally over to spring link 132 where a second end 146 of the second cable 144 connects to the spring link 132. As mentioned above, spring link 132 is connected to shackle 136, and shackle 136 is secured to both of the constant force springs 98, namely the end 138 of the first constant force spring, and the end 140 of the second constant force spring.

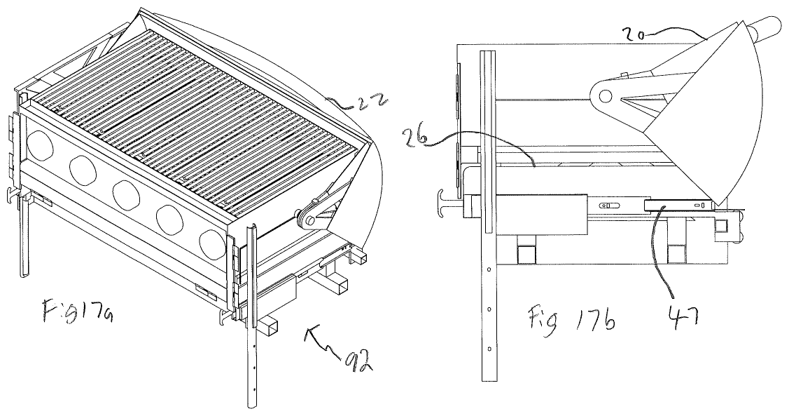

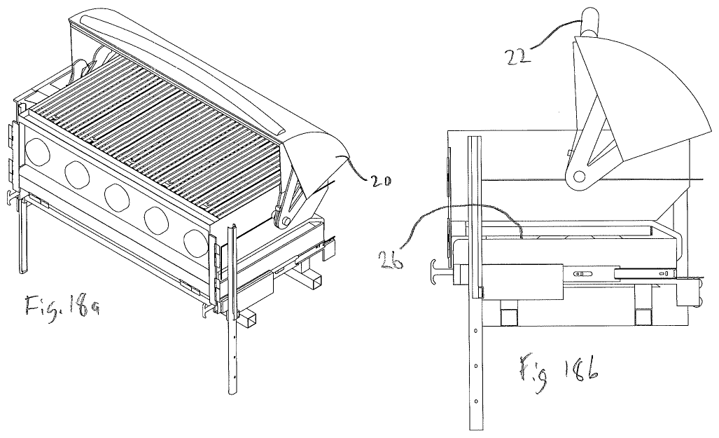

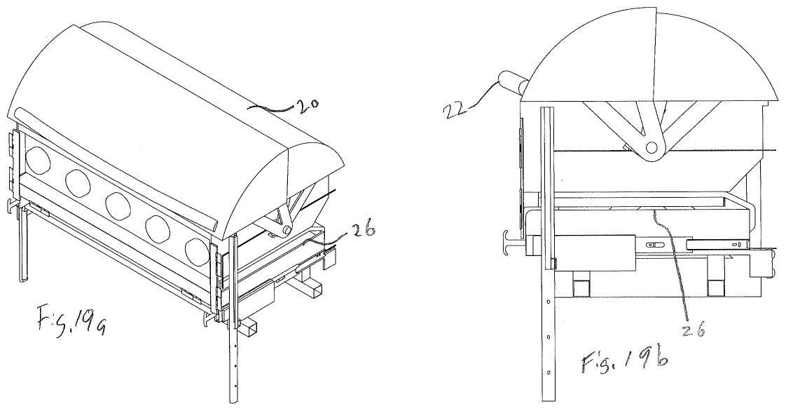

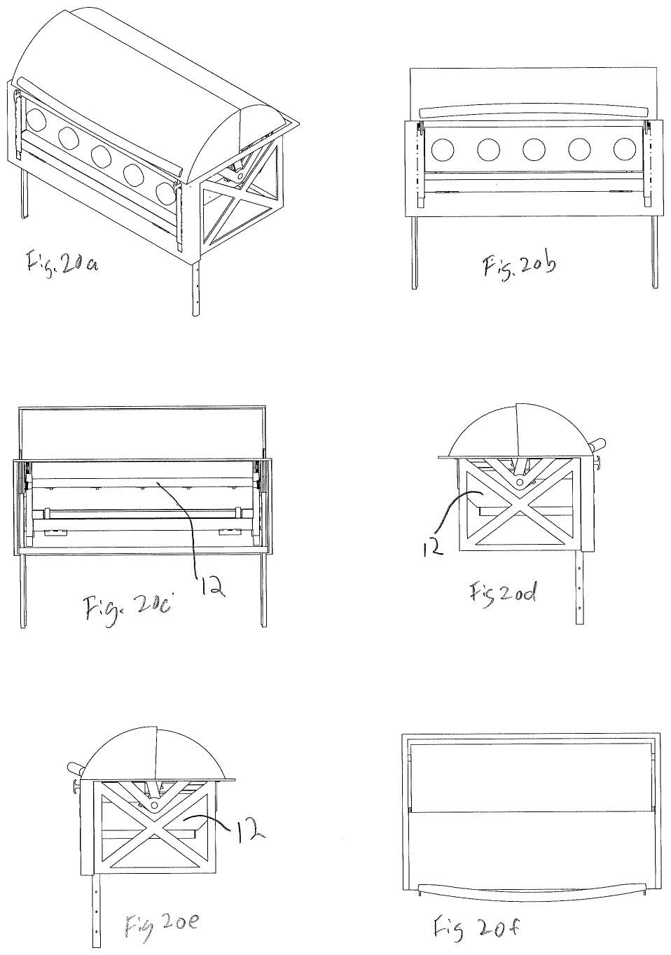

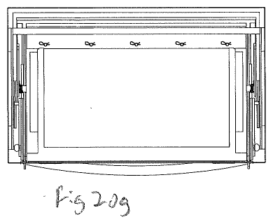

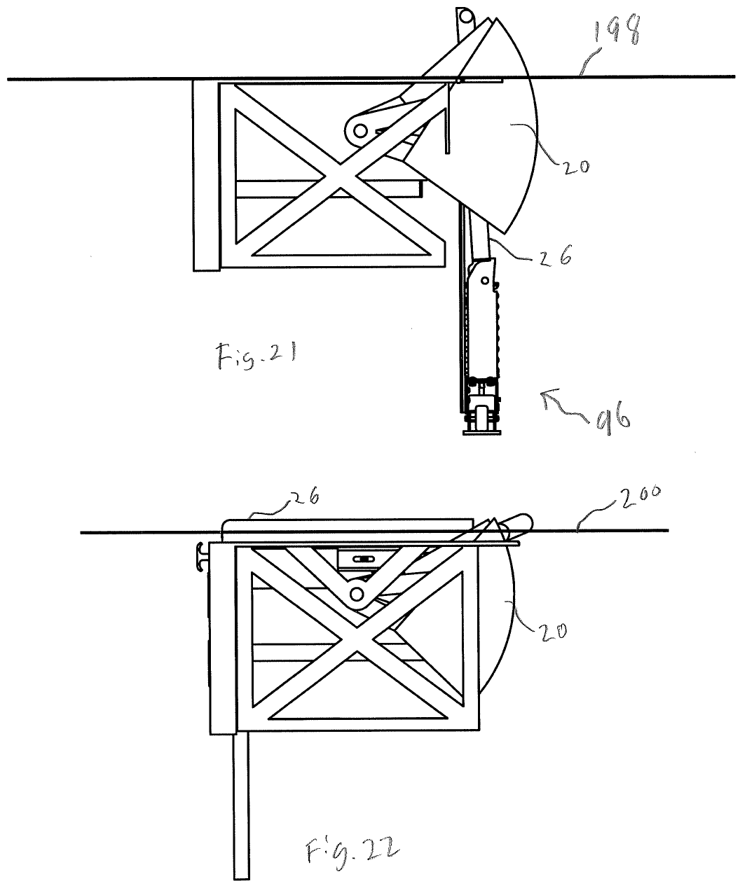

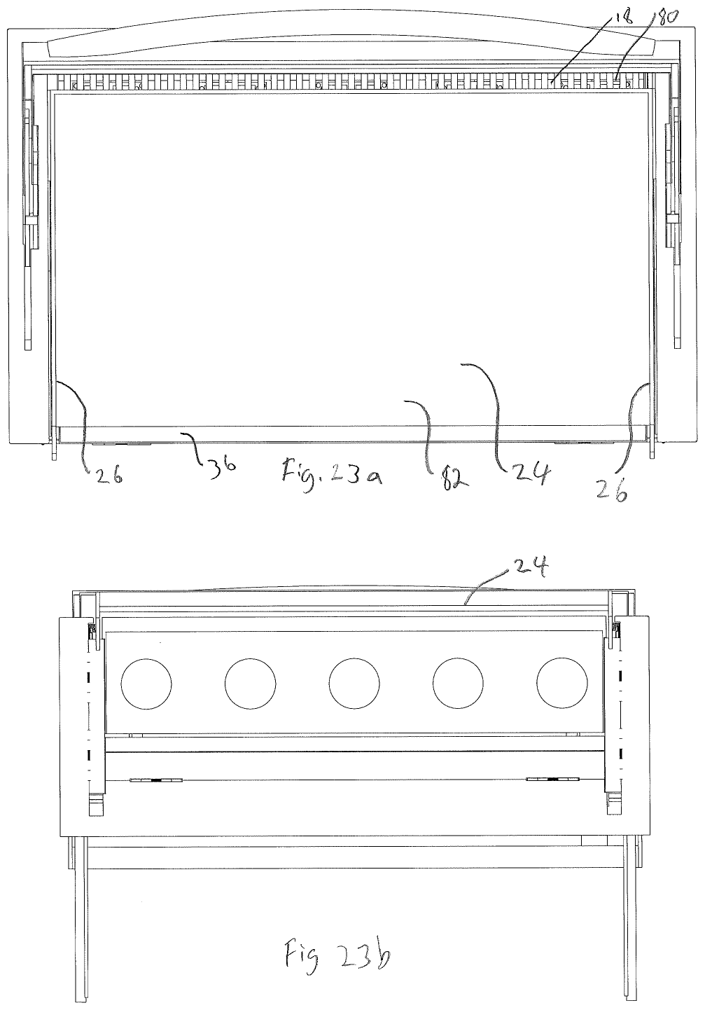

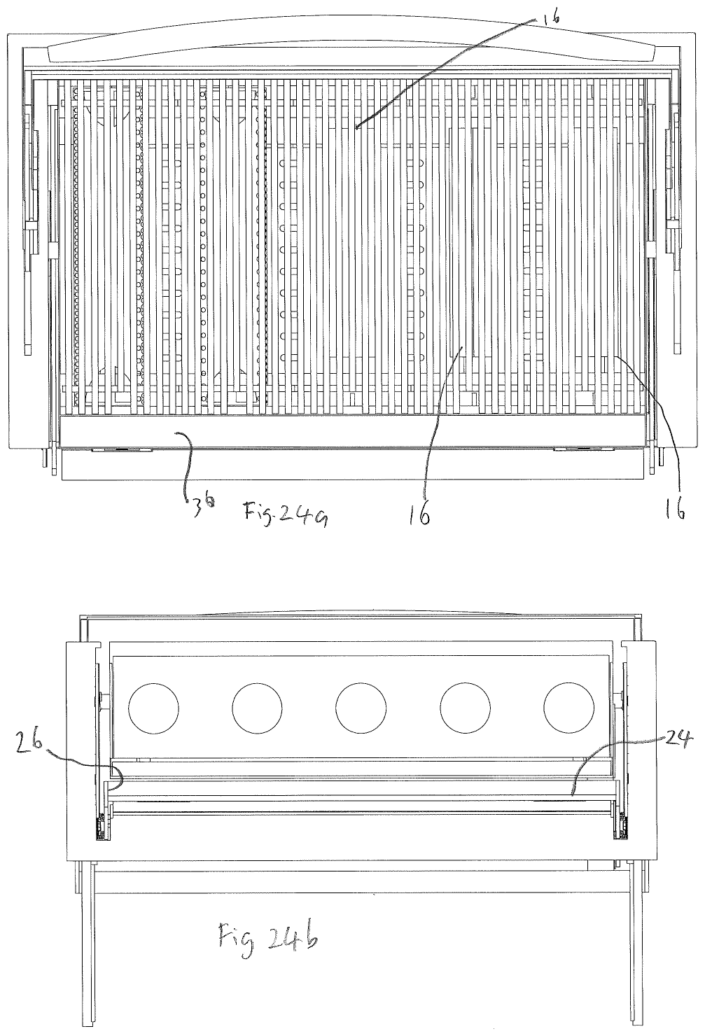

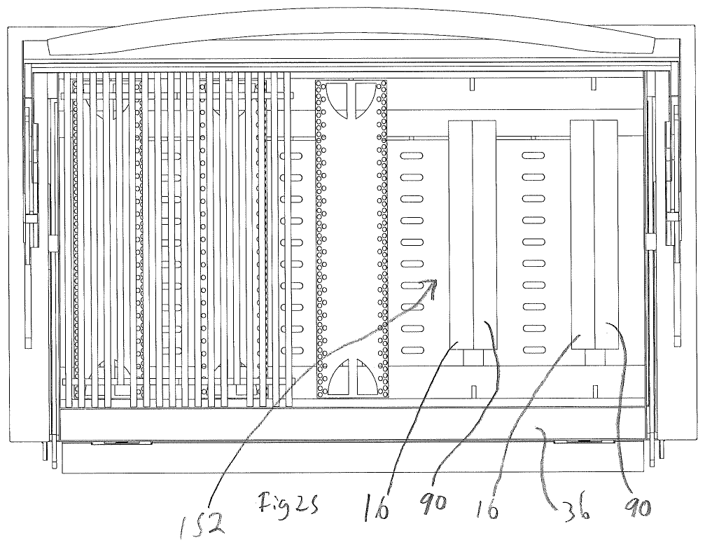

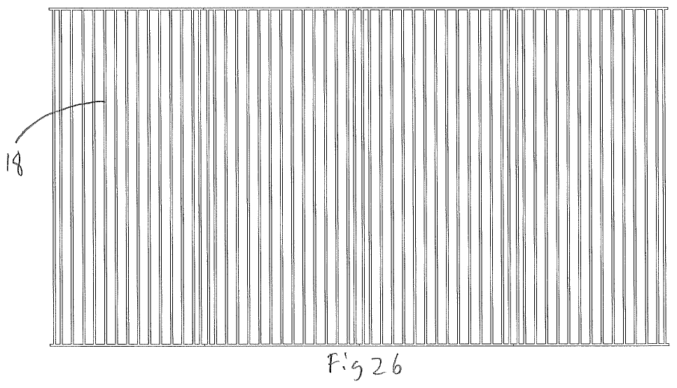

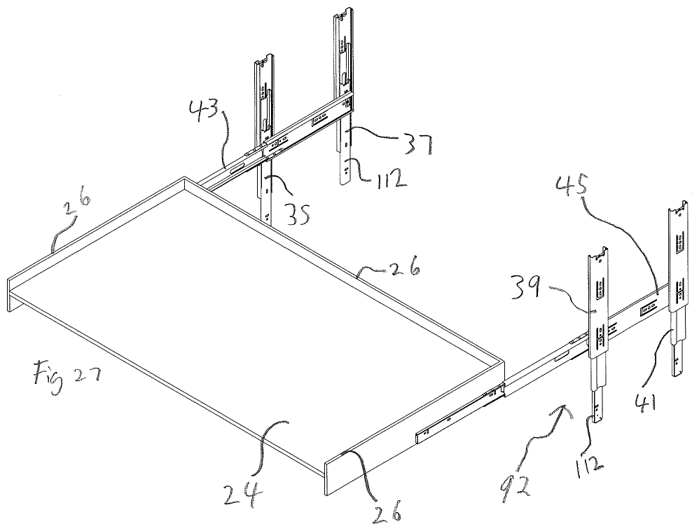

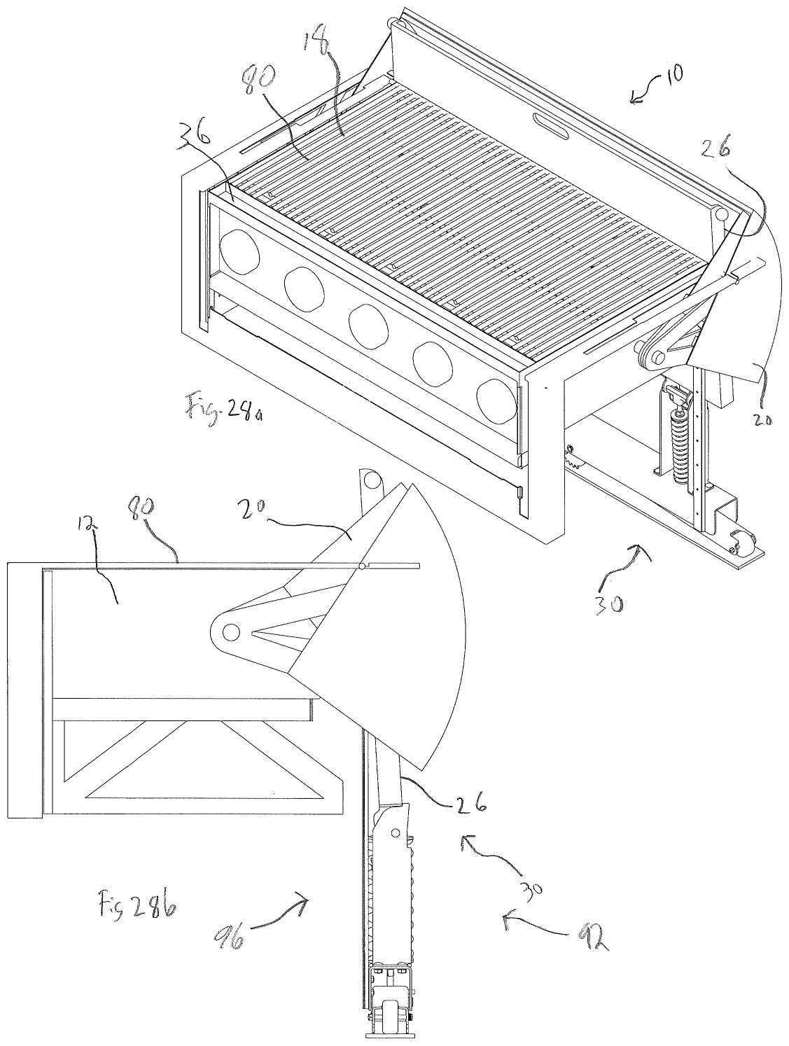

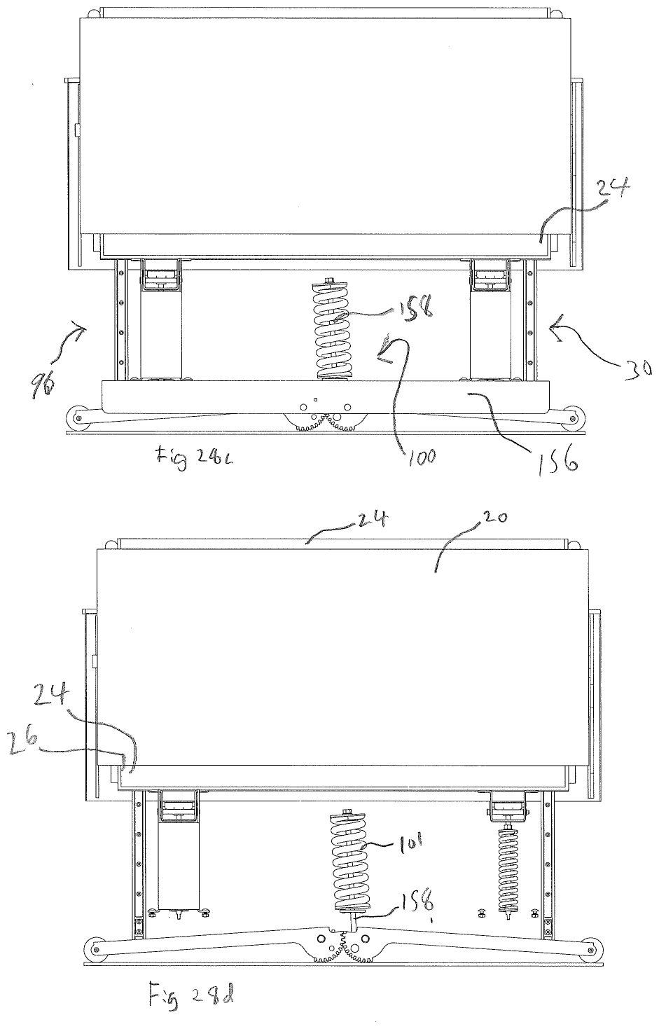

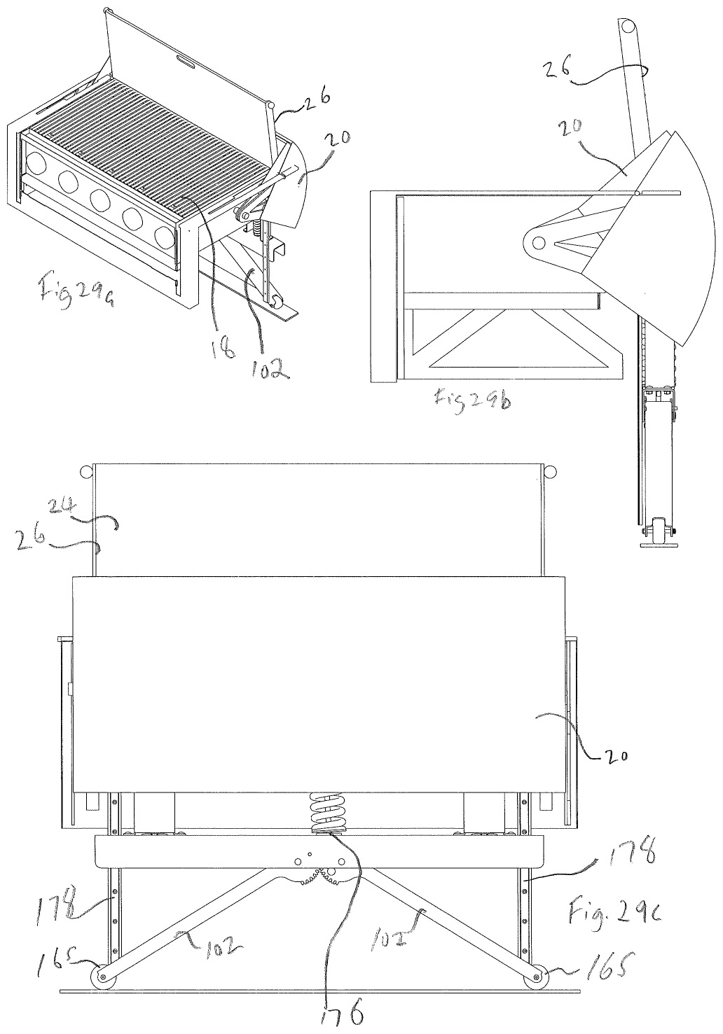

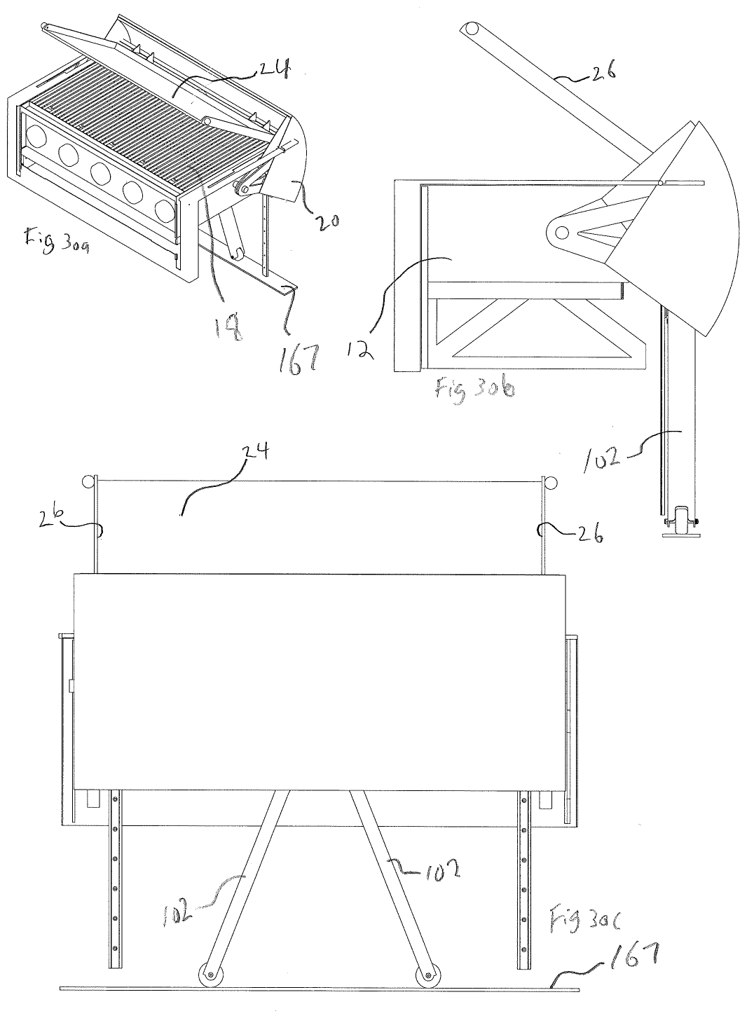

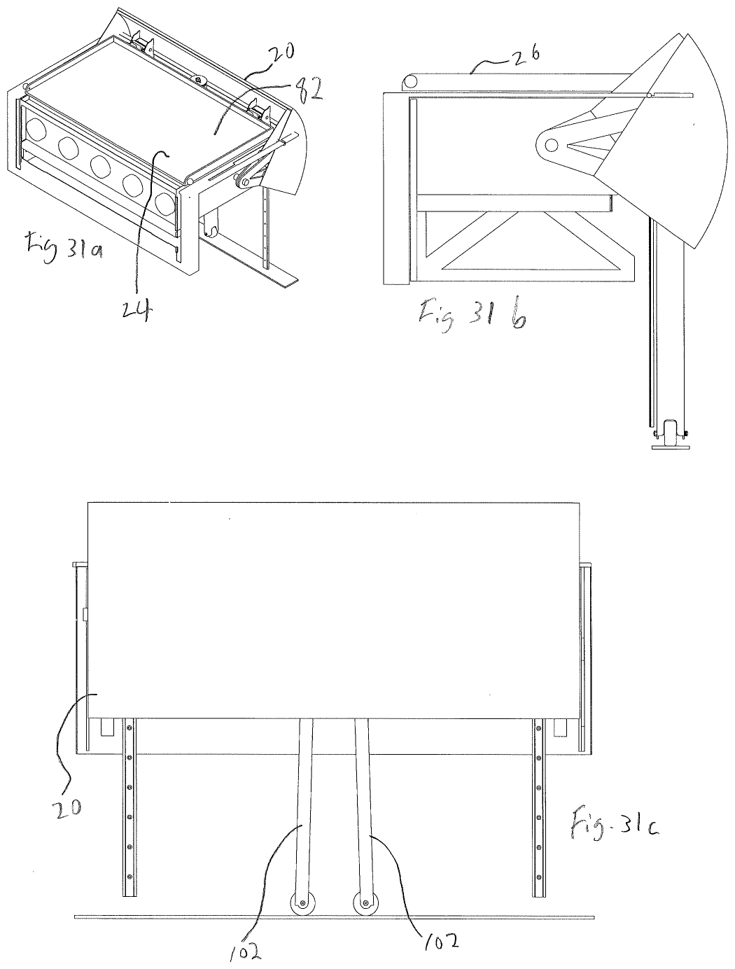

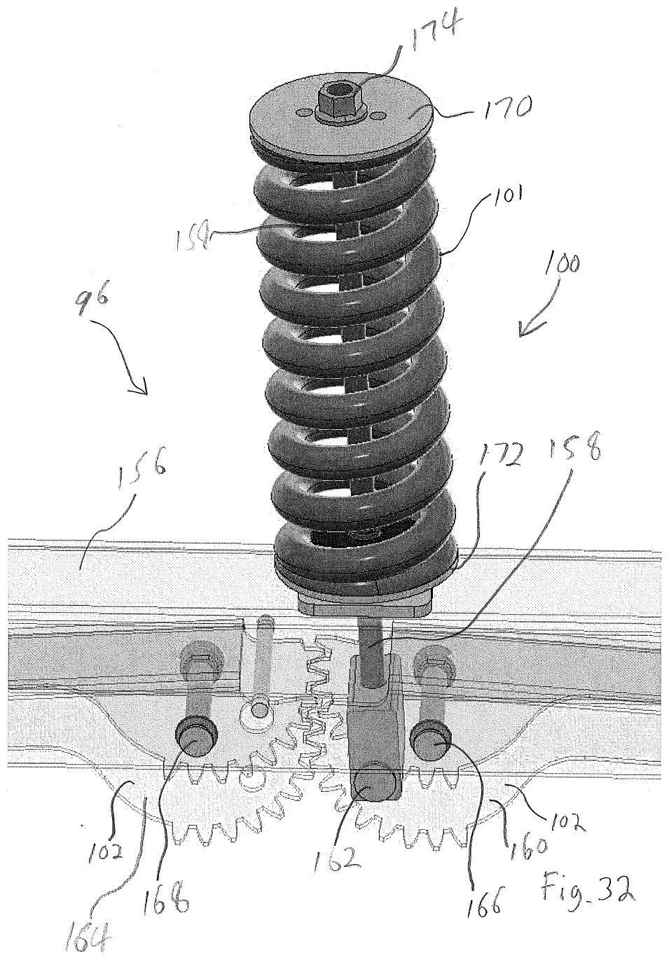

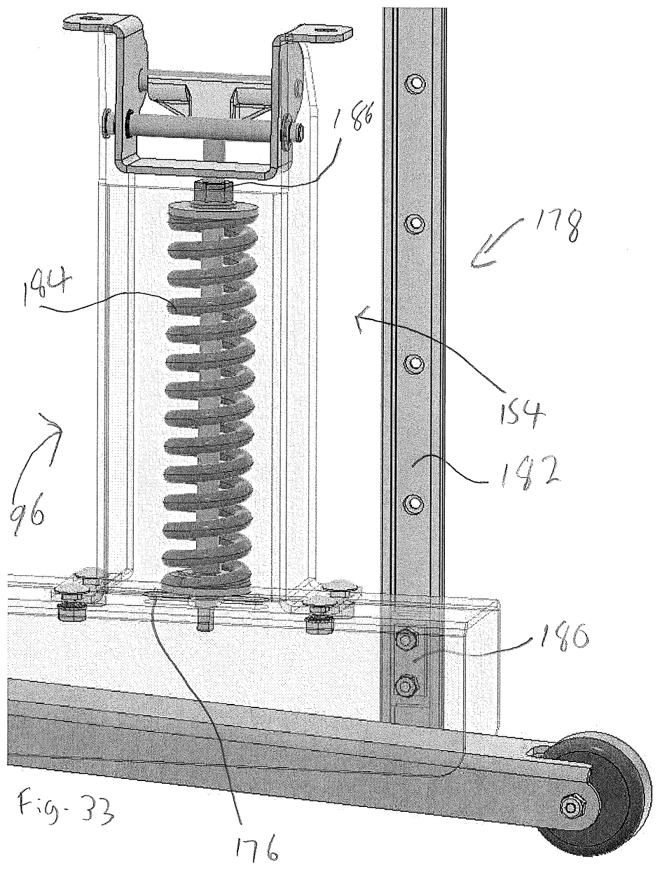

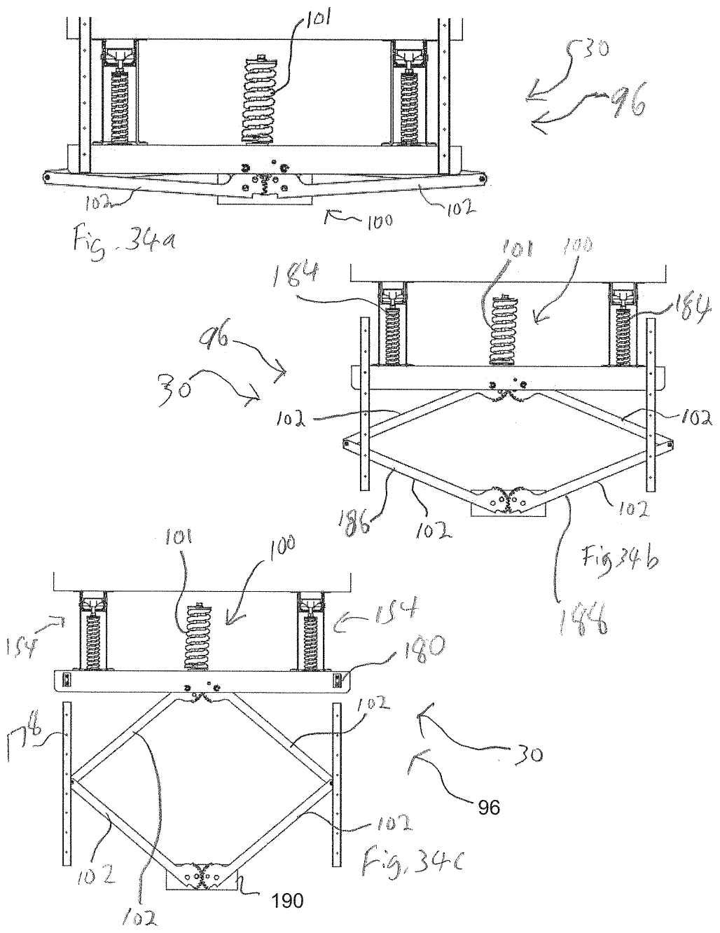

With the cable and pulley arrangement described above, both the left portion of the griddle plate 24 and the right portion of the griddle plate 24 are connected to a single, common force producing component (i.e. the two constant force springs 98 collectively) that produces the counterbalancing force of counterbalance mechanism 96 that is used to counterbalance the griddle plate 24 when the griddle plate 24 is moved vertically between a lowered position (FIG. 2) and a raised position (FIG. 3). By tying both the left and right portions of the griddle plate 24 to a common force producing component, the left and right portions of the griddle plate 24 are substantially restricted from moving vertically independently of the other. The tendency of a left and right portion of an object to move independently of each other (i.e. at different rates) when separate and independent force producing components produce separate and independent forces of the left and right portion of an object is typically referred to as racking. With the counterbalance mechanism of the embodiments depicted in FIGS. 1 to 8, including the fact that a pulley and cable system ties the left and right portions of the griddle plate to a common force producing component, vertical racking of the left and right portions of the griddle plate 24 can be effectively avoided.

In an embodiment, other apparatuses, devices, methods, etc. for reducing, eliminating, effectively eliminating, or substantially eliminating racking between the vertical movement of the left and right portions of the griddle plate 24 (and/or racking between horizontal movement of the left and right portions of the griddle plate 24) can include e.g. a rack and pinion system, a sprocket and chain system, a gear system, or the like. Such mechanisms can often reduce or eliminate vertical racking even if independent counterbalance force producing components are utilized for the left and right portions of an object, such as a griddle plate (e.g. even if the left and right portions of the griddle plate are not tied to a common counterbalance force producing component).

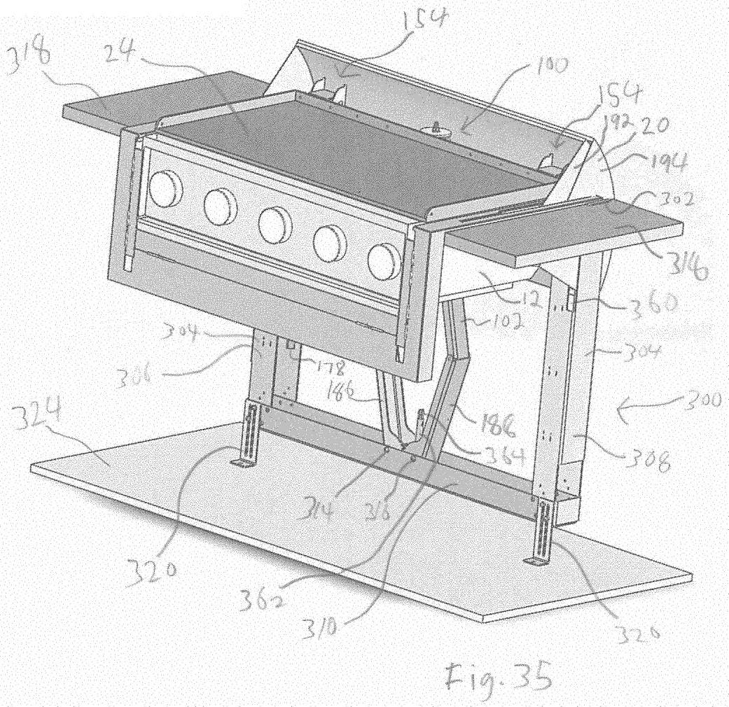

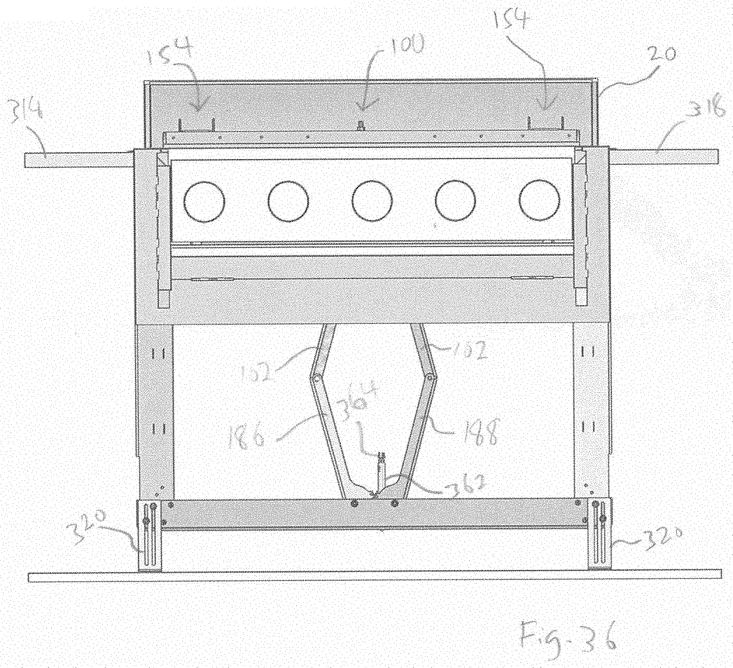

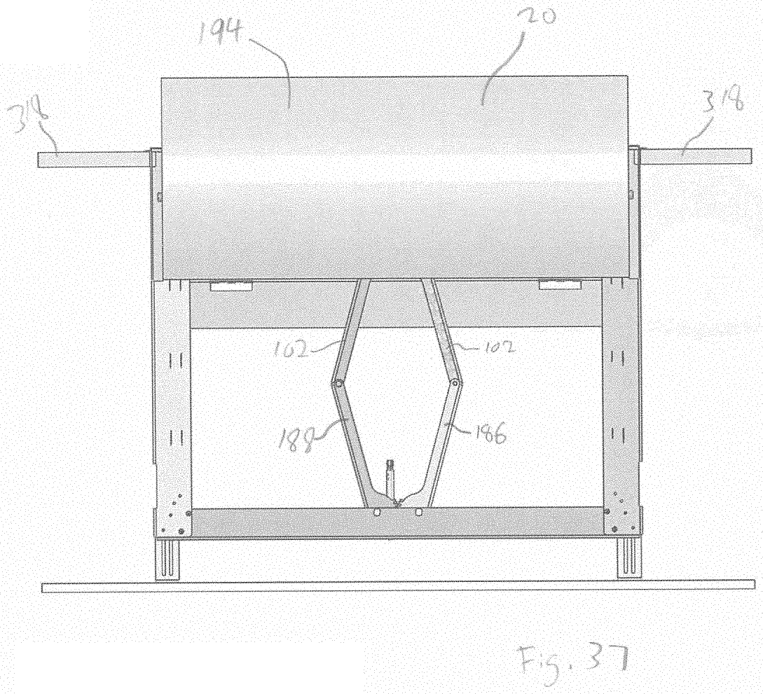

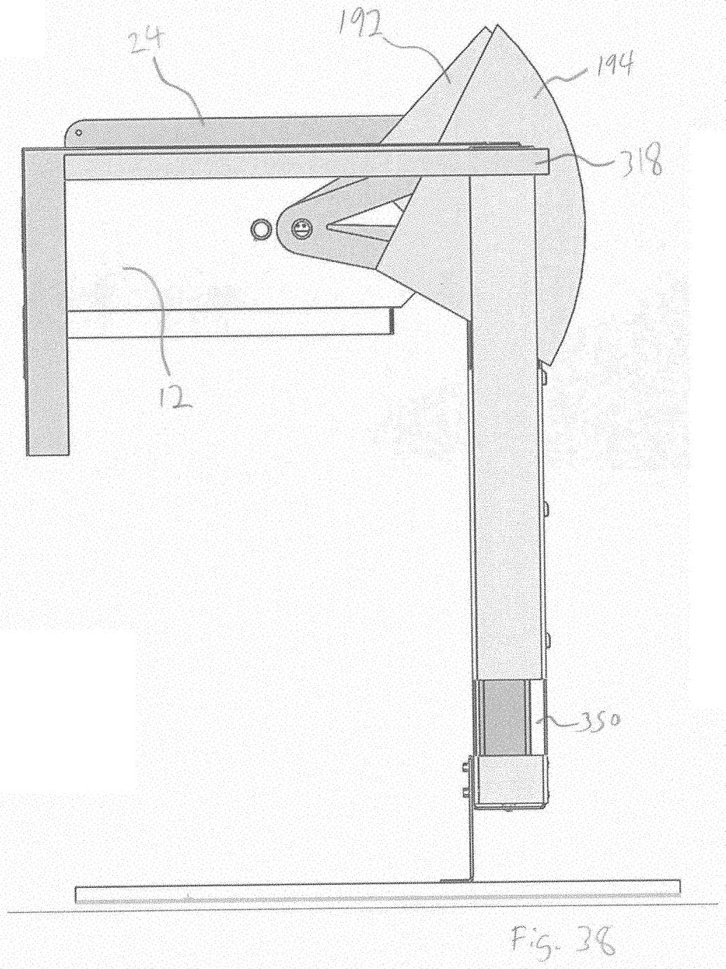

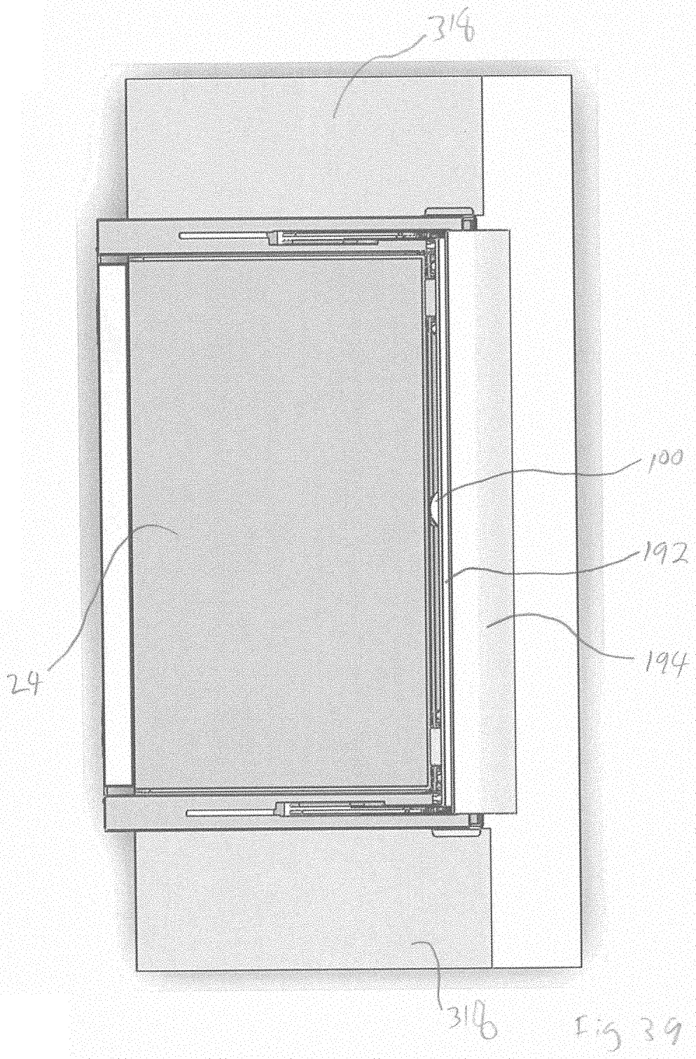

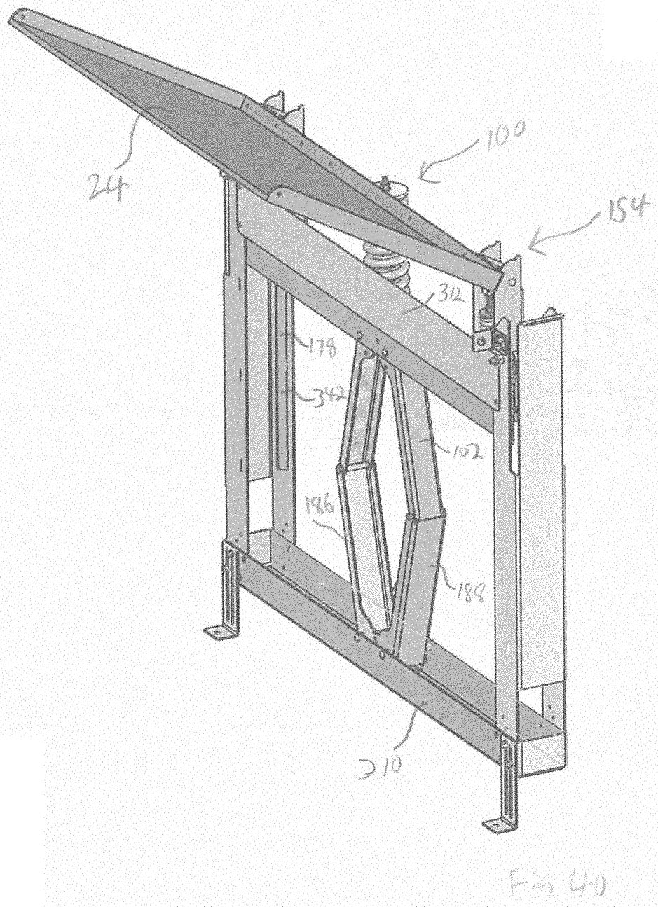

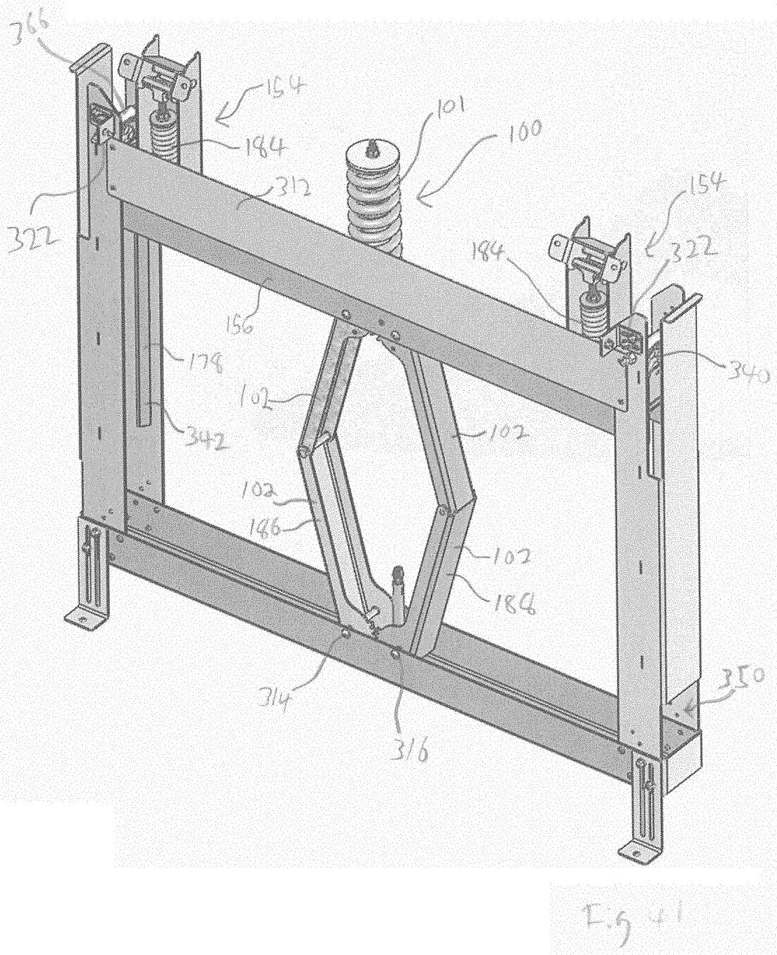

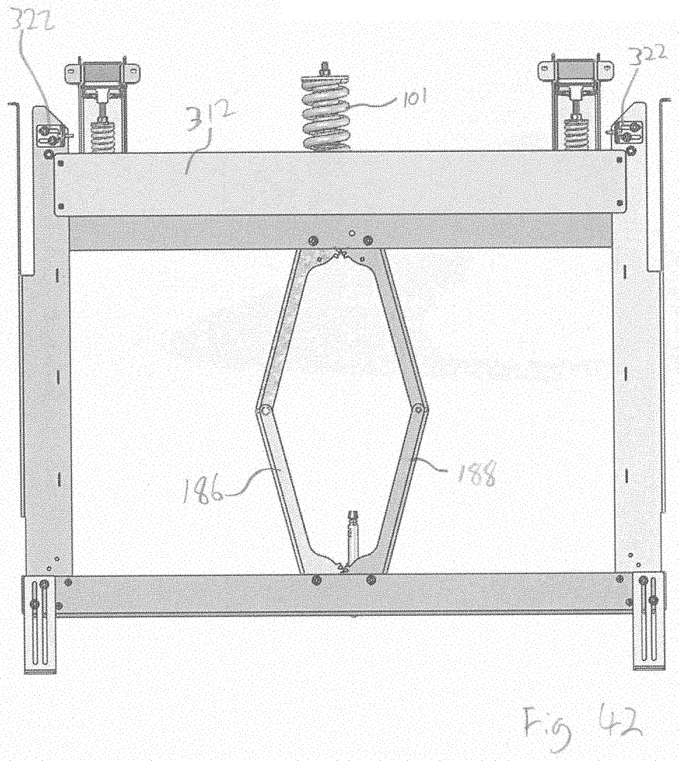

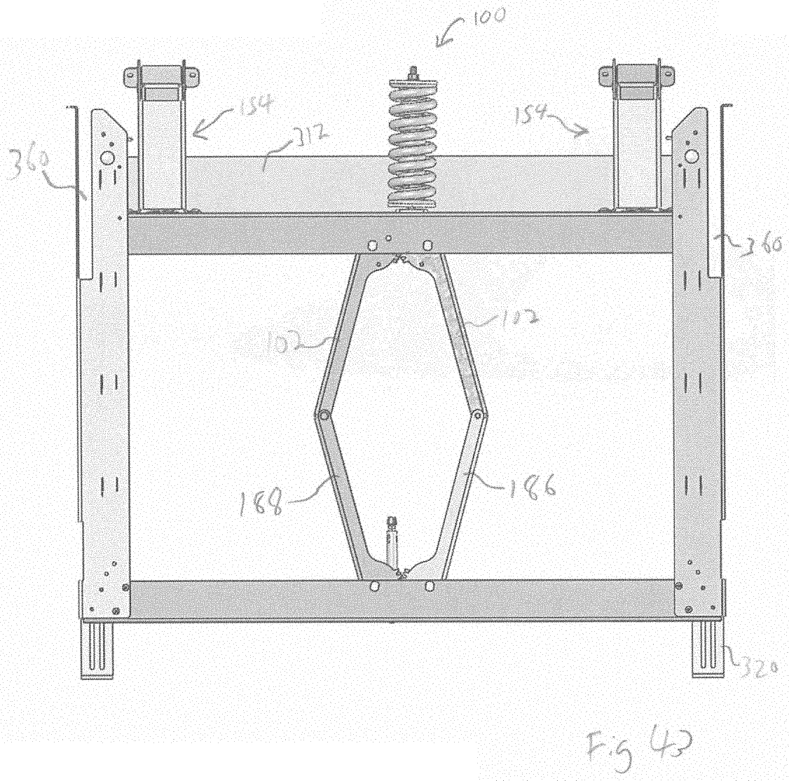

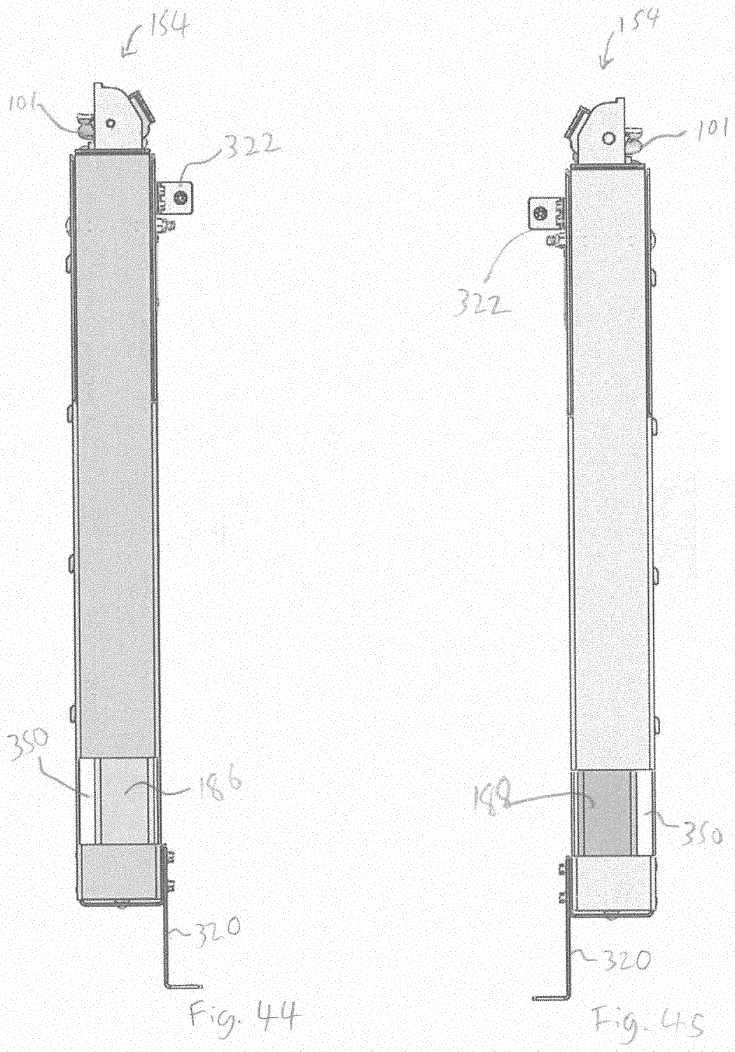

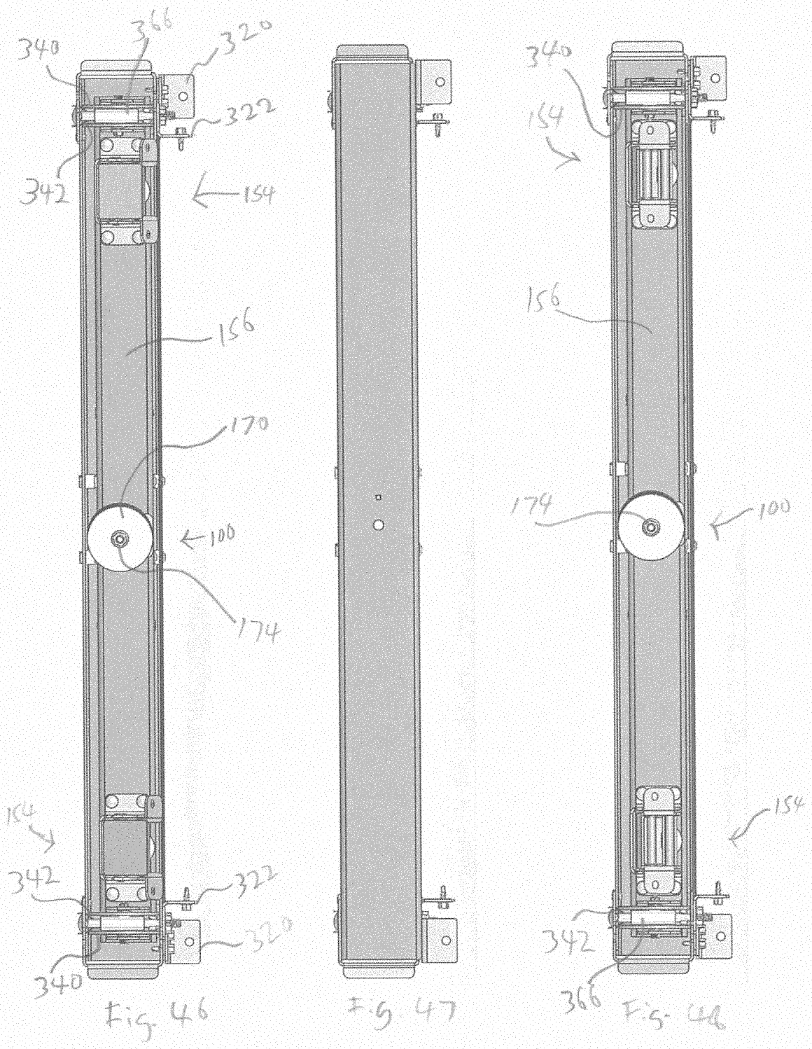

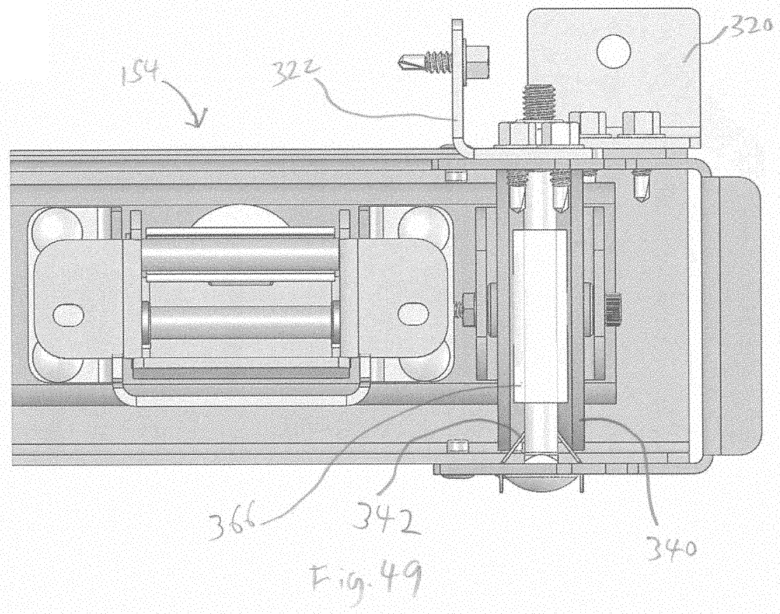

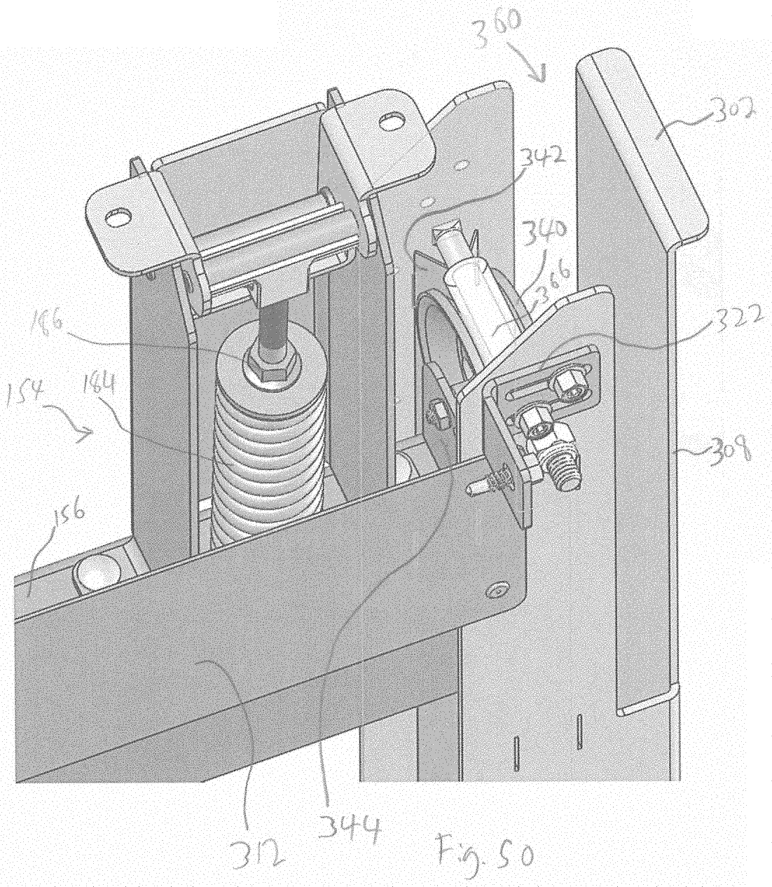

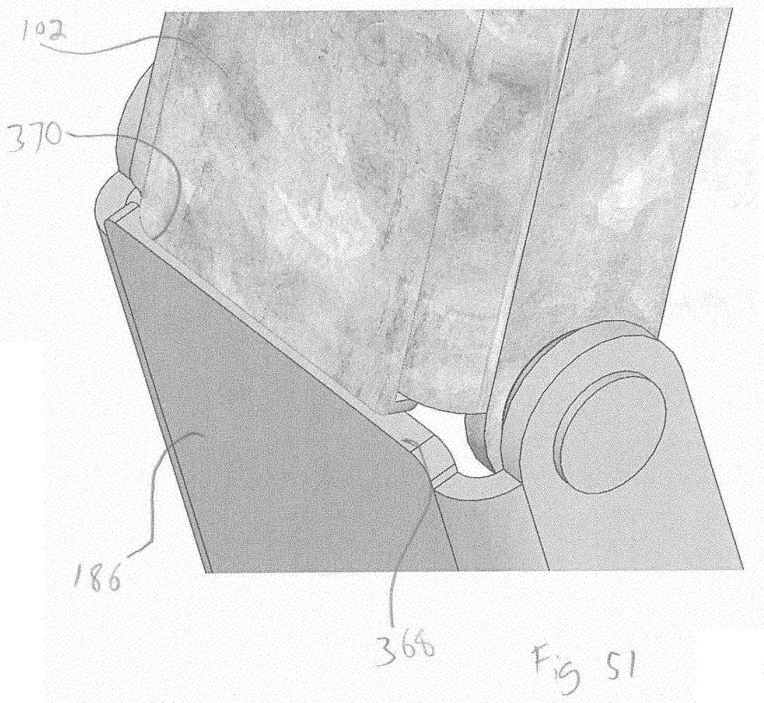

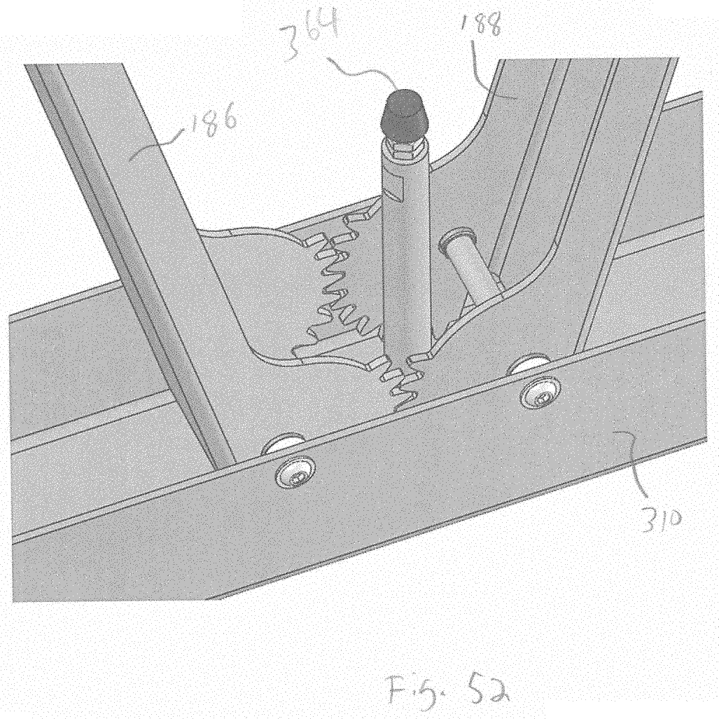

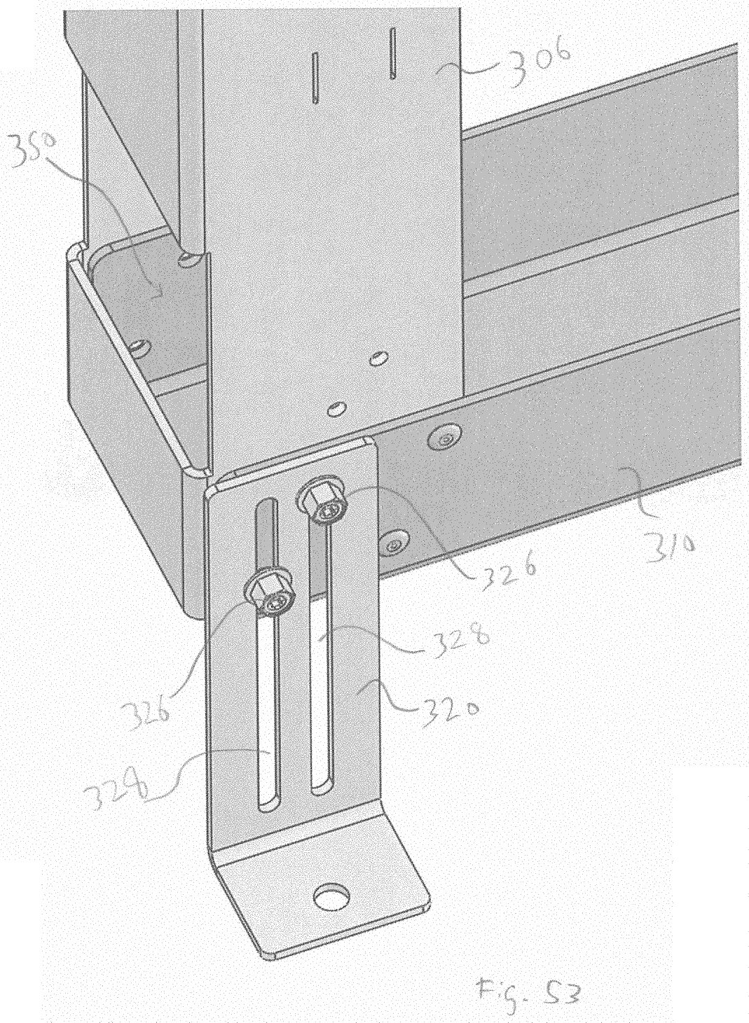

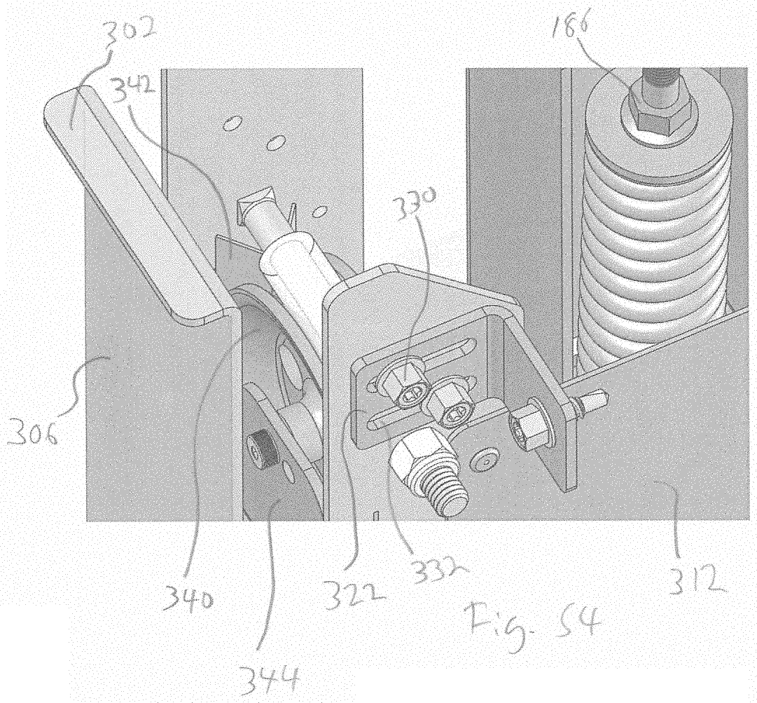

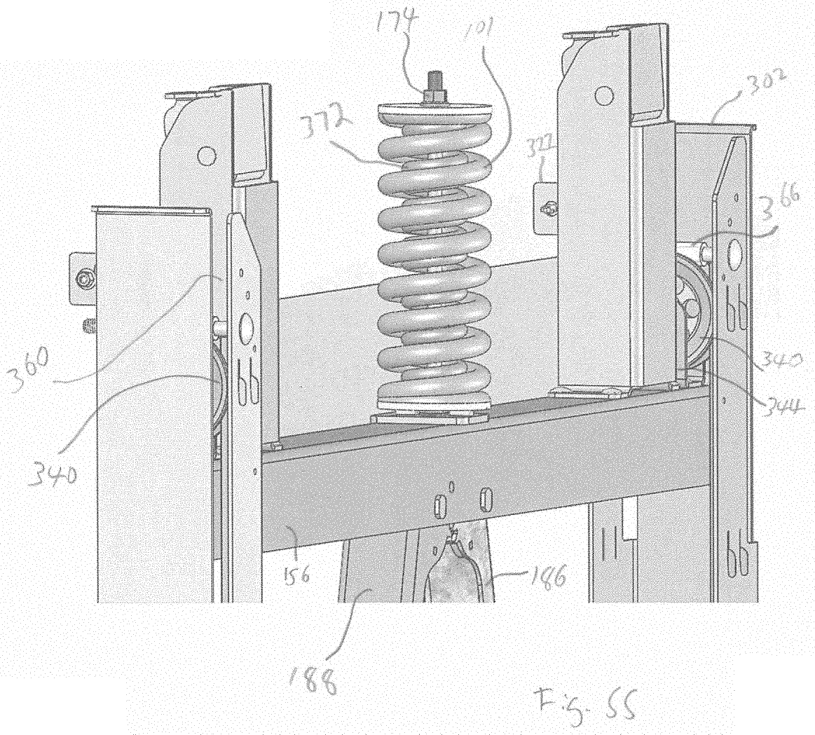

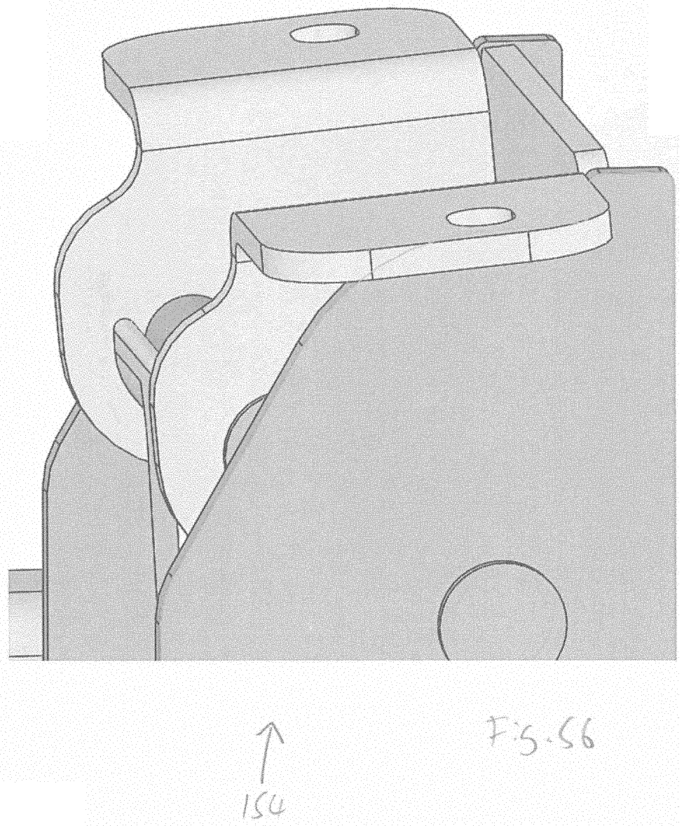

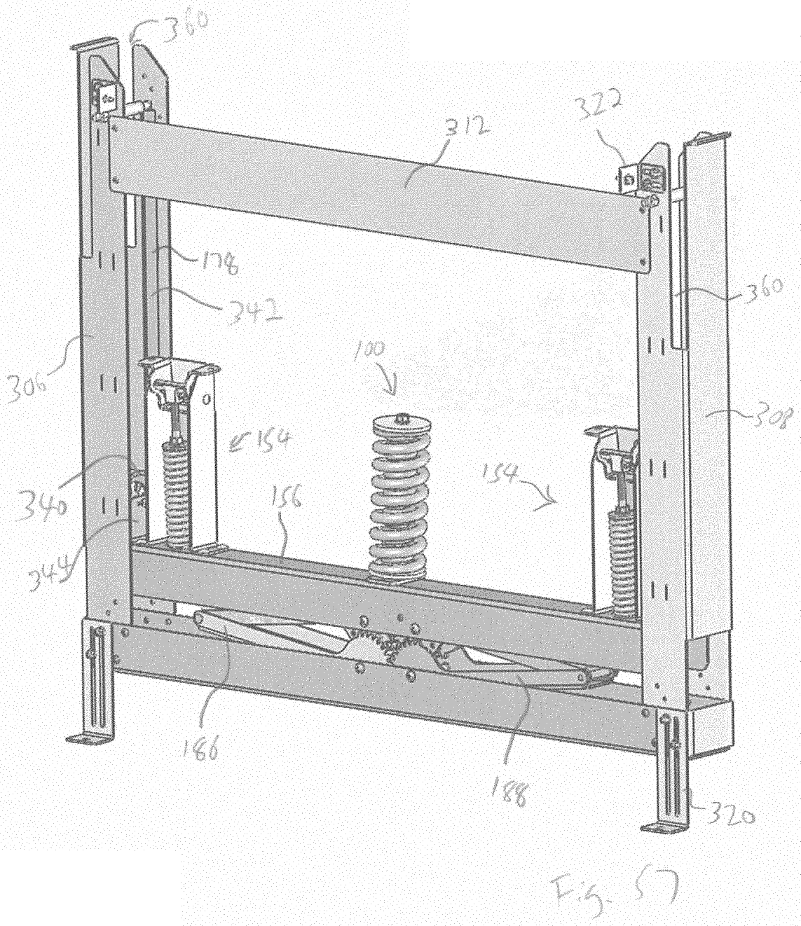

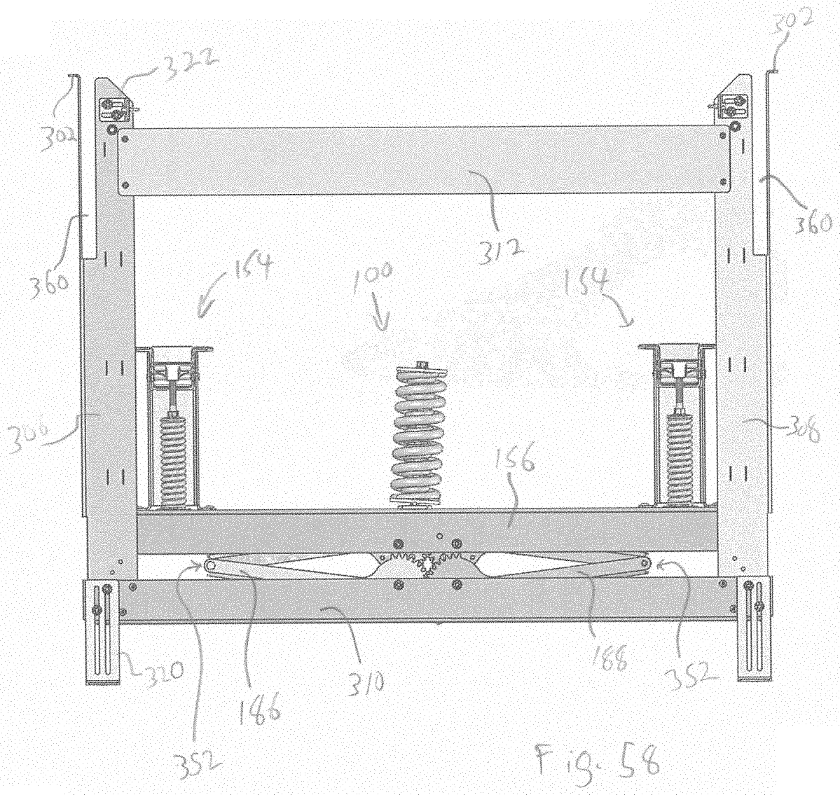

Referring still to the embodiment depicted in FIGS. 1 to 8, the grill can include a lid 20 (not shown in FIGS. 1 to 8), including any embodiments or configurations of a lid that are described herein, including any embodiments or configurations of a lid that are described herein for any other cooking apparatus or other object or thing. Additionally, as shown for example in FIGS. 2, 3, and 7, a portion of a lift mechanism, counterbalance mechanism, griddle, or related structures can include vent holes 148, which can allow combustion gases produced by a cooking heat source (e.g. burners) to vent out from between the griddle plate 24 and the fire box 152 of the grill, so that combustion gases do not become trapped in the fire box 152 by the griddle plate 24. In an embodiment, as is depicted in FIGS. 1 and 4, a winch 150 can be included, which can be used for pre-tensioning the constant force springs 98 and/or connecting the constant force springs 98 to the first cable 128 and the second cable 144.

In operation of the embodiment depicted in FIGS. 1 to 8, the griddle plate 24 is moveable between a cooking position where food items can be cooked on the griddle plate 24, and a stowed position, such that moving the griddle plate 24 to the stowed position exposes a portion of the grill grate 18, such that a portion of grill grate 18 is made available for cooking food items on the exposed portion of the grill grate 18.

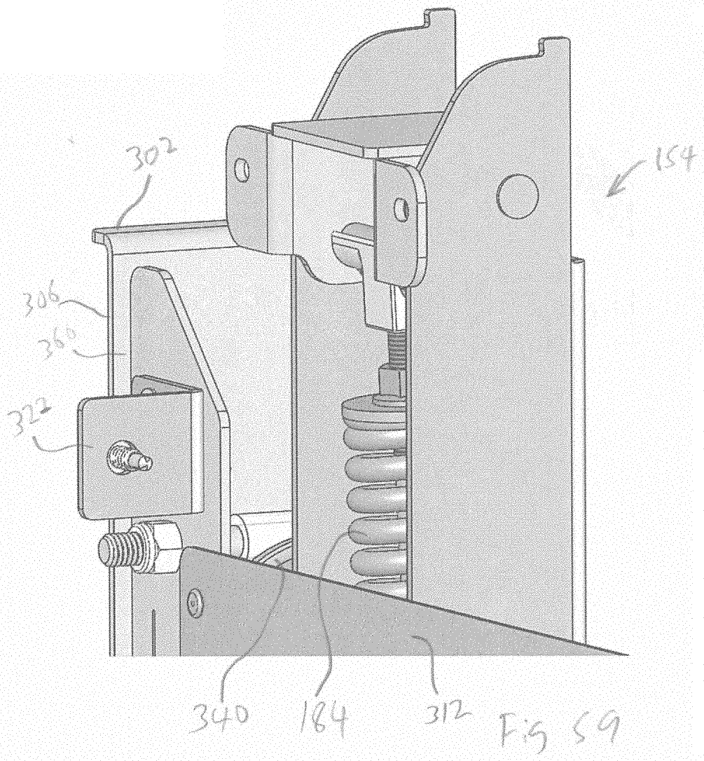

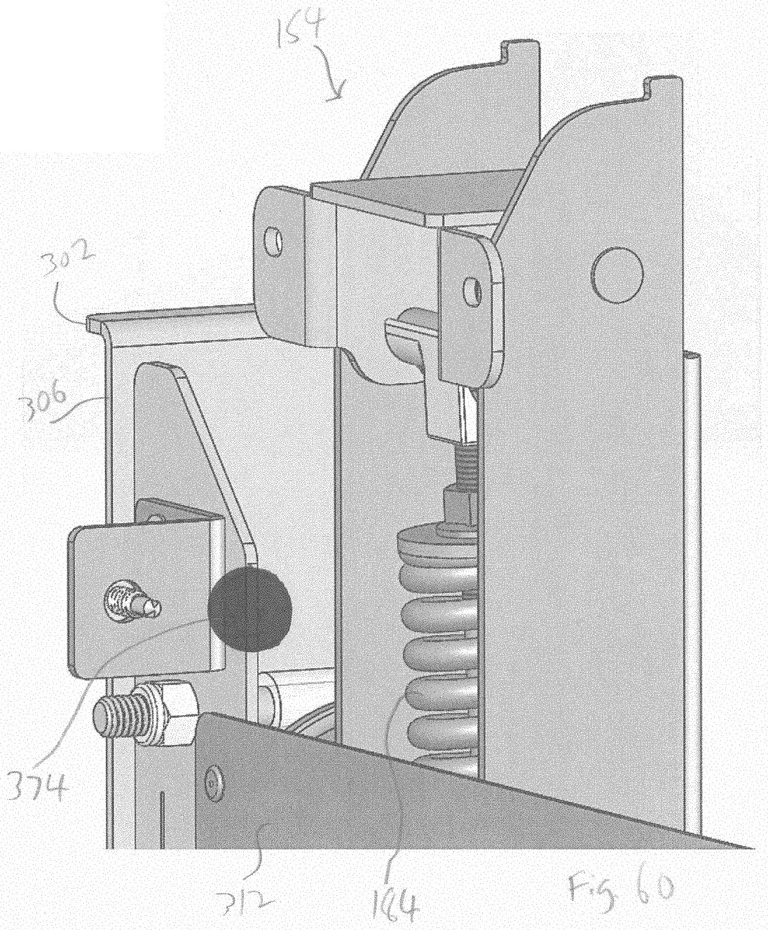

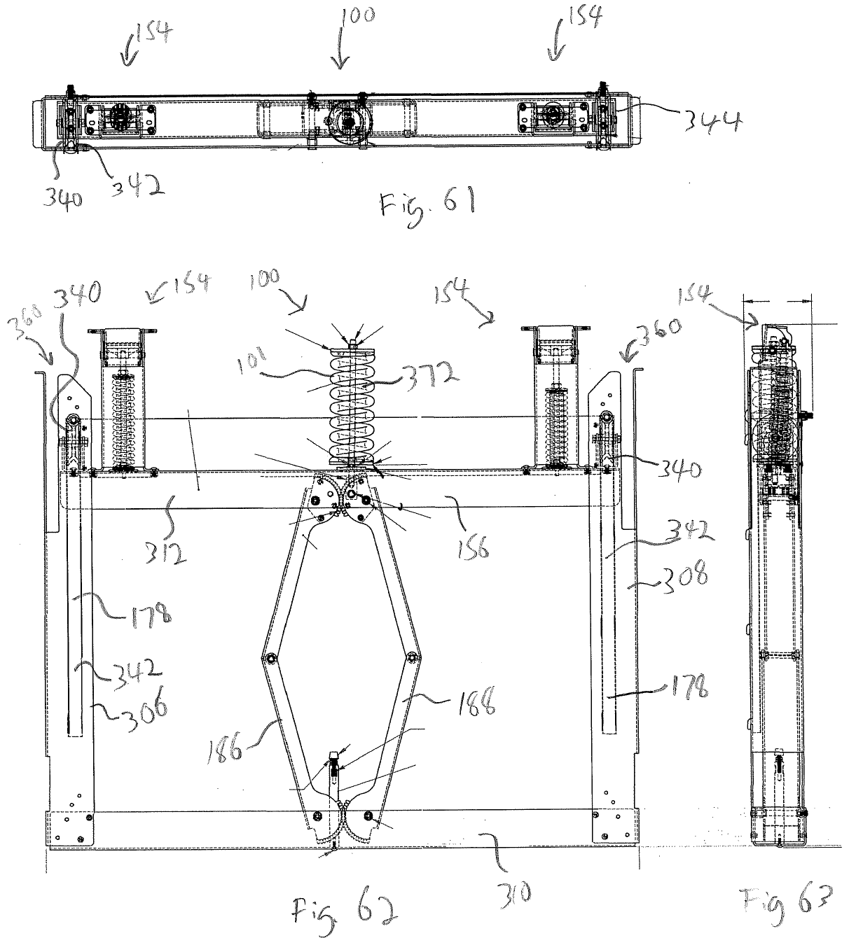

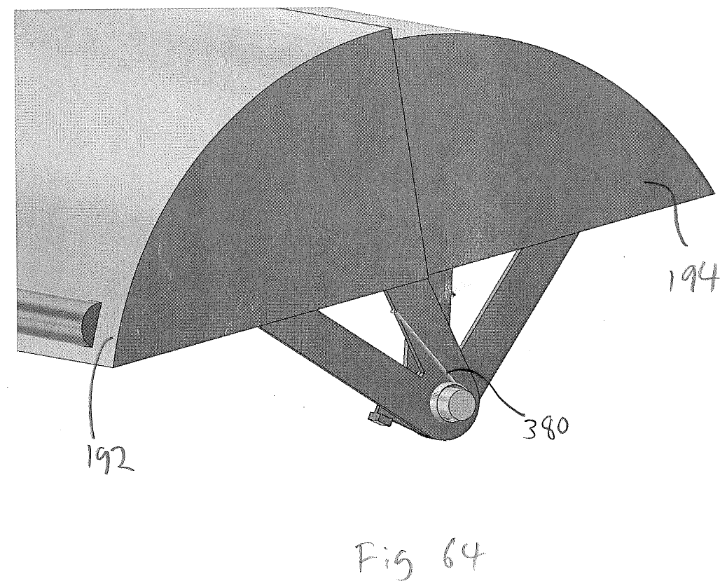

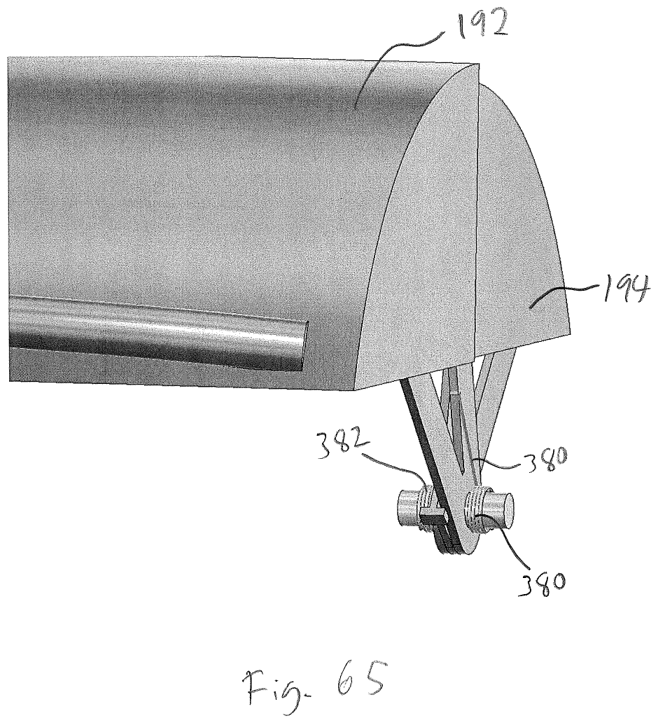

For example, as is depicted in FIGS. 1 to 8, the griddle plate 24 can be located in a stowed position (i.e. FIG. 1), such that food items can be cooked on the grill grate 18. If a user desires to cook food items on the griddle plate 24, the griddle plate 24 can be moved to a cooking position (i.e. FIGS. 4 and 6) by sliding or otherwise extending the griddle plate 24 horizontally via slides 43 and 45 until the griddle plate 24 reaches the position in FIG. 2 (i.e. an extended and lowered position). Next, the griddle plate can be moved vertically upward until it reaches the position in FIG. 3 (i.e. an extended and raised position), with the vertical slides 35, 37, 39, and 41 guiding the vertical movement of the griddle plate, with the vertical slides 35, 37, 39, and 41 handling the rotational strain, or torque, produced by the weight of the griddle plate 24 (particularly when the griddle plate 24 is in an extended position), so that the griddle plate 24 remains in a substantially horizontal orientation as it is moved between the cooking position and the stowed position. Due to the counterbalance mechanism 96 of the embodiments of FIGS. 1 to 8, a user can move the relatively heavy (e.g. 90 pounds or 40.8233 kilograms) griddle plate 24 between the raised position (FIG. 3) and the lowered position (FIG. 2). For example, in some embodiments, a user can move the 90 pound (40.8233 kilogram) griddle plate 24 upward or downward by applying only four pounds (1.81437 kilograms) of force on the griddle plate 24 in an upward or downward direction. As can be seen in FIGS. 4 and 5 (which are both rear perspective views of portions of the counterbalance mechanism), as the griddle plate 24 is moved from a lowered position (FIG. 5) to a raised position (FIG. 6), the force of the constant force springs 98 causes the constant force springs 98 to roll up, which pulls cables 128 and 144 and thereby provides the counterbalancing force to counterbalance the griddle plate 24 between the lowered position and the raised position.

To continue converting the griddle from a grill grate cooking configuration to a griddle plate cooking configuration, once the griddle plate has been moved vertically to the raised and extended position of FIG. 3, the griddle plate 24 can then be pushed towards the rear of the grill, with the griddle plate 24 traveling horizontally on slides 43 and 45, until the griddle plate 24 is moved into the cooking position, as shown in FIG. 4. The griddle plate 24 can now be heated by the same cooking heat source (e.g. burners) that is used to cook food on the grill grates 18 when the griddle plate 24 is in the stowed position, such that food items can be cooked on the griddle plate. When a user is ready to return to cooking food items on the grill grate 18, the griddle plate 24 can be moved from the cooking position to the stowed position by reversing the process described above.

In an embodiment, rather than being extendable and retractable along a path that is substantially parallel to the Earth's surface (or perpendicular to the direction of gravity), the griddle plate can move from a cooking position to a stowed position in other ways. For example, the front of the griddle plate can be moved in an upward direction while the rear of the griddle plate remains substantially fixed and serves as a point of rotation about which the griddle plate rotates as the font of the griddle plate is raised. The front of the griddle plate can be raised until the griddle plate is substantially perpendicular to the Earth's surface (or substantially parallel to the direction of gravity). In some embodiments, the entire griddle plate can then be moved downward such that the griddle plate moves into a stowed position behind the grill body and below the grill grate. In some embodiments, one or more counterbalances, such as a counterbalance mechanism employing a gas spring, constant force spring, or other spring(s), can assist in moving the front of the griddle plate in an upward direction and/or moving the griddle plate downward into a stowed position.

For example, referring to the embodiments depicted in FIGS. 28 to 34, a device, such as a cooking apparatus 10, such as a grill, can have a grill body 12, a grill grate 18, and a griddle plate 24. The grill can have a lift mechanism 30, which can be a counterbalance mechanism such as counterbalance mechanism 96, which is capable of counterbalancing the weight or force exerted by the griddle plate 24 when the griddle plate 24, or a portion of the griddle plate 24, is moved vertically. The counterbalance mechanism 96 can itself include two or more counterbalance mechanisms, such as counterbalance mechanism 100 and counterbalance mechanism 154, as is the case of the embodiments depicted in FIGS. 28 to 34.

As depicted in FIGS. 28 to 34, the griddle plate can be connected to a counterbalance mechanism 96 that is made up of two or more distinct types of counterbalance mechanisms, such as counterbalance mechanisms 100 and 154. For example, in the embodiments shown in FIGS. 28 to 34, the first counterbalance mechanism 100 provides a counterbalancing force that is relatively constant through its range of motion, and the second counterbalance mechanism 154 provides counterbalancing force that varies through its range of motion.

As another example, in the embodiments shown in FIGS. 28 to 32 and 34, the counterbalance mechanism 100 uses a compression spring 101 in conjunction with lever arms 102 to provide a relatively constant counterbalancing force for the griddle plate 24 as the counterbalance mechanism 100 moves the griddle plate 24 vertically (e.g. up and down).

In the embodiments depicted in FIGS. 28 to 32, portions of the counterbalance mechanisms 100 and 154 are mounted to mounting bracket 156. In FIG. 28d, mounting bracket 156 has been removed in order to make some underlying structures visible. The counterbalance mechanism 100 can include a compression spring 101, held between upper spring retainer 170 and a lower spring retainer 172, with a spring rod 158 extending down through the center of the coil of the compression spring 101, and through an opening in the mounting bracket 156, where the lower end of the spring rod 158 pivotally connects to first lever arm 160 at pivotal connection 162. First lever arm 160 and second lever arm 164 are pivotally connected to mounting bracket 156 at pivotal connections 166 and 168 respectively. The spring 101 is held against the mounting bracket 156, and is compressed between upper spring retainer 170 and lower spring retainer 172, by the weight of the griddle plate 24 biasing the first lever arm in a counterclockwise direction (relative to FIGS. 28d and 32), such that the pivotally attached spring rod 158 and upper spring retainer cap 170 are biased in a downward direction, thereby compressing the spring 101.

The compressive force of the spring 101 exerts a counteracting upward force on the upper spring retainer 170, which in turn transmits an upward force to the attached spring rod, 158. In operation, in the embodiment depicted in FIGS. 28 and 32, when a upward force is applied to the griddle plate 24 (e.g. by a user), the first lever arm 160 rotates clockwise with the second lever arm 164 rotating counterclockwise at the same rate (due the engagement of the gear teeth of the first lever arm 160 with the gear teeth of the second lever arm). Due to the force of the spring 101, when the griddle plate is moved vertically (e.g. when the griddle plate 24 is moved between the position depicted in FIG. 28 and the position depicted in FIG. 30), the spring 101, in conjunction with the varying length of the effective lever arm created by the first lever 160 and the second lever arm 164, results in the counterbalance mechanism 100 producing a relatively constant counterbalancing force throughout the range of motion of the counterbalance mechanism 100. More particularly, as the griddle plate 24 is raised, the first lever arm 160 rotates clockwise, and the spring 101 is decompressed (and therefore exerts less force), the rotation of the first lever arm 160 and second lever arm 164 results in a the effective length of the lever arm created by first lever arm 160 and second lever arm 164 being varied. Due to the actual length of the first lever arm 160 and the second lever arm 164, the rotation of the first lever arm 160 and the second lever arm 164, and the resulting variance in the effective length of the lever arm, is able to compensate for the decreasing force of the spring 101 such that the counterbalancing force of the counterbalance mechanism 100 remains relatively constant in spite of the decreasing force exerted by the spring 101.

The first lever arm 160 and second lever arm 164 include wheels 165, which roll along and push against plate 167. Plate 167 can be connected to an external support structure (not shown), in order to provide a secure foundation for the counterbalance mechanism 96.

The counterbalance mechanism 100 also includes an adjustable nut 174, which can be tightened or loosened in order to adjust the compression of spring 101. Additionally, the spring mechanism of the counter balance mechanism 100 (as well as the spring mechanism of counterbalance mechanism 154) can rest on a ridge 176 of the mounting bracket 156, which can allow the spring mechanism to rock back on fourth, relative to the mounting bracket 156, on the ridge 176. This can provide the spring mechanism with a degree of movement that can compensate for the non-linear movement of the spring rod 158 (or the spring rod of counterbalance mechanism 154) due to the rotation of the components that the respective spring rods are attached to.

In the embodiment depicted in FIGS. 28 to 32, the counterbalance mechanism 96 includes extendable rails 178 that are slidably engaged with the griddle plate 24, such that when the extendable rail extends (via the carriage 180 of the extendable rail sliding or traveling along the track 182 of the extendable rail 178), the griddle plate is moved (e.g. moved vertically, as in the embodiment depicted in FIG. 29. Similar to the extendable rails (i.e. vertical slides) of the embodiment depicted in FIGS. 1 to 8, the extendable rails 178 can guide the vertical movement of the griddle plate, and can account for the torque produced by the griddle plate 24, particularly as the griddle plate approaches a cooking position (the griddle plate is shown in a stowed position in FIG. 28, a cooking position in

FIG. 31, and is shown approaching a cooking position in FIG. 30).

Referring still to FIGS. 28 to 32, the counterbalance mechanism 154 provides a counterbalancing force that counterbalances the torque of the griddle plate 24 as the griddle plate 24 rotates between a substantially horizontal orientation (FIG. 31) and a substantially vertical orientation (FIG. 28). In this embodiment, the force exerted by the springs 184 is used to counterbalance the torque of the griddle plate 24. The counterbalance mechanism 154 is configured such that as the torque exerted by the griddle plate 24 decreases as the griddle plate 24 rotates towards a vertical orientation, the force exerted by the springs 184 decreases proportionally as the compression of the springs 184 is reduced (i.e. the decreasing force exerted by the springs 184 matches the decreasing torque of the griddle plate 24). Similarly, as the griddle plate 24 rotates from a more vertical orientation towards a more horizontal orientation, the force exerted by the springs 184 increases (as the compression of the springs 184 increases) to match the increasing torque exerted by the griddle plate 24. In this manner, the torque of the griddle plate 24 can be counterbalanced by the counterbalance mechanism 154 throughout the range of rotation of the griddle plate 24. Similar to adjustment nut 174 of counterbalance mechanism 100, counterbalance mechanism 154 includes an adjustment nut 186 that can be used to adjust the compression of the springs 184.

In FIGS. 34a to 34c, an alternative embodiment of a counterbalance mechanism is shown in which wheels 165 have been replaced with a pivotal connection to an additional pair of lever arms, namely third lever arm 186 and fourth lever arm 188, which are in turn pivotally connected to support bracket 190, which can be connected to an external support structure (not shown) in order to provide a sturdy foundation for the counterbalance mechanism. Due to the arrangement of the four pivotally connected lever arms as depicted in FIGS. 34a to 34c, the mechanism is able to achieve approximately double the vertical travel distance of an object (e.g. griddle plate) connected to the mechanism, but with the mechanism having approximately the same width as the embodiments depicted in FIGS. 28 to 32.

In FIGS. 35 to 63, another embodiment is shown which includes counterbalance mechanisms 100 and 154. A support frame 300 is provided, and includes support tabs 302, a pair of vertical support members 304 (namely first vertical support member 306 and second vertical support member 308), lower horizontal support member 310, and upper horizontal support member 312. Third lever arm 186 and fourth lever arm 188 are pivotally connected to lower horizontal support member 310 and pivots 314 and 316. In the embodiments shown in FIGS. 35 to 39, support frame 300 is suspended from a weight supporting member (such as kitchen counter 318) by tabs 302, with the tabs 302 resting on the top side of kitchen counter 318. Via this arrangement, kitchen counter 318 can support all, or substantially all, of the weight of the support frame 300, griddle plate 24, counterbalance mechanisms 100 and 154, and all of the components that work in conjunction with counterbalance mechanisms 100 and 154 to provide the counterbalancing function to the griddle plate 24 (including lever arms 102 and mounting bracket 156).

Stabilizing brackets 320 and 322 can be connected to support frame 300, and can provide horizontal stability the support frame 300. Stabilizing brackets 320 can be connected to an external support structure, such as the ground or a floor 324. Via this arrangement, stabilizing brackets 320 can provide horizontal stability to the lower portion of the support frame 300 by preventing or substantially preventing the lower portion of the support frame 300 from moving horizontally relative to the floor 324. The stabilizing brackets' 320 connection to the support frame 300 can be adjustable (e.g. by being slidably engaged to the support frame via bolts 326 and channels 328), which can allow the stabilizing brackets 320 to be connected to floors of varying distance from the support frame 300.

Similarly, stabilizing brackets 322 can be connected to an external support structure, such as a wall or grill body 12. Via this arrangement, stabilizing brackets 320 can provide horizontal stability to the upper portion of the support frame by preventing or substantially preventing the upper portion of the support frame 300 from moving horizontally relative to the floor 324. Similar to stabilizing brackets 320, stabilizing brackets' 322 connection to the support frame can be adjustable via bolts 330 and channels 332.

In this embodiment, extendable rails 178 include a V-guide track 342 secured to the first vertical support member 306 and the second vertical support member 308, and also includes complementary V-rollers 340. The V-rollers 340 are slidably engaged with the corresponding V-guide tracks 342 via the V-roller's 340 ability to roll vertically along the V-guide tracks 342 as the griddle plate 24 is moved vertically. The V-rollers 340 are rotatably connected to V-roller bracket 344, which is in turn secured to mounting bracket 156.

Vertical support members 306 and 308 can include openings 350. In some embodiments, for example in embodiments in which the grill body 12 and griddle plate 24 are not as wide as the embodiment depicted in FIG. 35, vertical support members 306 and 308 can be configured such that they are closer to each other than what is depicted in FIG. 35, so that the width of the support frame 300 can be narrowed to correspond to the narrowed width of the grill body 12 and griddle plate 24. In some such embodiments, openings 350 can allow the end portions 352 of lever arms 102 to extend through the walls of the vertical support members 306 and 308 (by extending through openings 350) when the griddle plate 24 is moved to the stowed position.

Vertical support members 306 and 308 can also include slots 360, which extend vertically along a length of the vertical support members 306 and 308. Slots can include a first slot 360 which extends vertically though vertical support member 306 of support frame 300, and a second slot 360 which extends vertically through vertical support member 308 of support frame 300.

As depicted in FIGS. 35 to 39, slots 360 can allow the first lid portion (sometimes referred to herein as “first lid”) 192 to move from the closed position to the open position without contacting or otherwise being obstructed by the support frame 300. Similarly, slots 360 can allow the second lid portion (sometimes referred to herein as “second lid”) 194 to move from the closed position to the open position without contacting or otherwise being obstructed by the support frame 300. In FIGS. 35 to 39, first lid 192 is depicted in an open position (sometimes referred to herein as a “first lid open position”), and second lid 194 is depicted in an open position (sometimes referred to herein as a “second lid open position”). Conversely, in FIGS. 10, 11a, and 11b, first lid 192 is depicted in a closed position (i.e. a “first lid closed position”), and second lid 194 is depicted in a closed position (i.e. a “second lid closed position”).

As depicted in FIGS. 35 to 39, in an embodiment, when the first lid 192 is moved from a closed position to an open position, a first portion of the first lid 192 extends through the slot 360 of vertical support member 306 of support frame 300, and a second portion of the first lid 192 extends through the slot 360 of vertical support member 308 of support frame 300. Similarly, when the second lid 194 is moved from a closed position to an open position, a first portion of the second lid 194 extends through the slot 360 of vertical support member 306 of support frame 300, and a second portion of the second lid 194 extends through the slot 360 of vertical support member 308 of support frame 300.

When the first lid 192 is rotated from an open position to a closed position, the first portion of the first lid 192 (i.e. the first portion of the first lid 192 that extended through the slot 360 of vertical support member 306 when the first lid 192 was in the open position) is rotated out of the slot 360 of vertical support member 306, such that when the first lid 192 is in the closed position, this first portion of the first lid 192 does not extend through the slot 360 of vertical support member 306. When the first lid 192 is rotated from the open position to the closed position, the second portion of the first lid 192 (i.e. the second portion of the first lid 192 that extended through the slot 360 of vertical support member 308 when the first lid 192 was in the open position) is rotated out of the slot 360 of vertical support member 308, such that when the first lid 192 is in the closed position, this second portion of the first lid 192 does not extend through the slot 360 of vertical support member 308.

When the second lid 194 is rotated from an open position to a closed position, the first portion of the second lid 194 (i.e. the first portion of the second lid 194 that extended through the slot 360 of vertical support member 306 when the second lid 194 was in the open position) is rotated out of the slot 360 of vertical support member 306, such that when the second lid 194 is in the closed position, this first portion of the second lid 194 does not extend through the slot 360 of vertical support member 306. When the second lid 194 is rotated from the open position to the closed position, the second portion of the second lid 194 (i.e. the second portion of the second lid 194 that extended through the slot 360 of vertical support member 308 when the second lid 194 was in the open position) is rotated out of the slot 360 of vertical support member 308, such that when the second lid 194 is in the closed position, this second portion of the second lid 194 does not extend through the slot 360 of vertical support member 308.

Dampeners can be provided to cushion the movement of the counterbalance mechanism and associated components as the griddle plate approaches the upper end and lower end of its vertical travel path. For example, dampener 362 can be connected to horizontal support member 310, and can include a compressible tip, such as rubber tip 364. As the griddle plate approaches the lower end of its vertical travel path, rubber tip 364 comes into contact with mounting bracket 156, thereby stopping the vertical movement of the mounting bracket 156 (and the indirectly connected griddle plate 24) in a cushioned manner.

Similarly, dampeners 366 can be located at the upper end of the travel path of the V-rollers 340. As the griddle plate 24 approaches the upper end of its vertical travel path, dampeners 366 come into contact with V-rollers 340, thereby stopping the vertical movement of the V-rollers (and the indirectly connected griddle plate 24). In an embodiment, as the griddle plate approaches the upper end of its vertical travel path, stop tabs 368 and 370, located at the end portions 352 of lever arms 102, can come into contact with each other and provide some or all of the stopping force that stops the vertical movement of the griddle plate.

In some embodiments, such as the embodiments depicted in FIGS. 55 and 62, counterbalance mechanism 100 can include two springs. More particularly, counterbalance mechanism 100 can include compression spring 101, as well as an additional compression spring 372 that is located inside the cavity created by the coils of compression spring 101. In such an embodiment, the combined force of spring 101 and spring 372 can provide the counterbalancing force for the vertical movement of the griddle plate 24 that is provided by counterbalance mechanism 100.

Referring to the embodiment depicted in FIG. 60, when the griddle plate is vertically oriented, in certain positions along its vertical travel path, including during all of or a portion of the vertical movement of the griddle plate, the griddle plate can be biased in a generally horizontal direction, such as for example by being pushed horizontally rearward relative to the grill body 12 (i.e. with the griddle plate being biased away from the grill grate). For example, roller 374 (which can include a roller, wheel, or other friction reducing component) can be employed to bias the griddle plate rearward. In the embodiment depicted in FIG. 60, roller 374 is rotatably connected to vertical support member 306, and can push against the bottom side of the griddle plate (not show in FIG. 60), with roller 374 rolling as the griddle plate is moved vertically (which can reduce friction between the roller and the griddle plate). A similar roller 374 can be rotatably connected to vertical support member 308, and can perform a similar function on the other side of the griddle plate. In another embodiment, rather than being rotatably connected to the vertical support member 306, the roller(s) can be rotatably connected to other structures, such as the rear area of the grill body.

By biasing the griddle plate rearward, the various components that interconnect the griddle plate 24 to the lower horizontal support member 310 (e.g. counterbalance mechanisms 154, mounting bracket 156, lever arms 102, and associated joints) are flexed, which can remove at least some of the play that can exist between these components. In this manner, the griddle plate can be at least partially restricted from rocking back and forth (i.e. rocking rearward and forward relative to the grill body) when the griddle plate is in the vertical orientation.

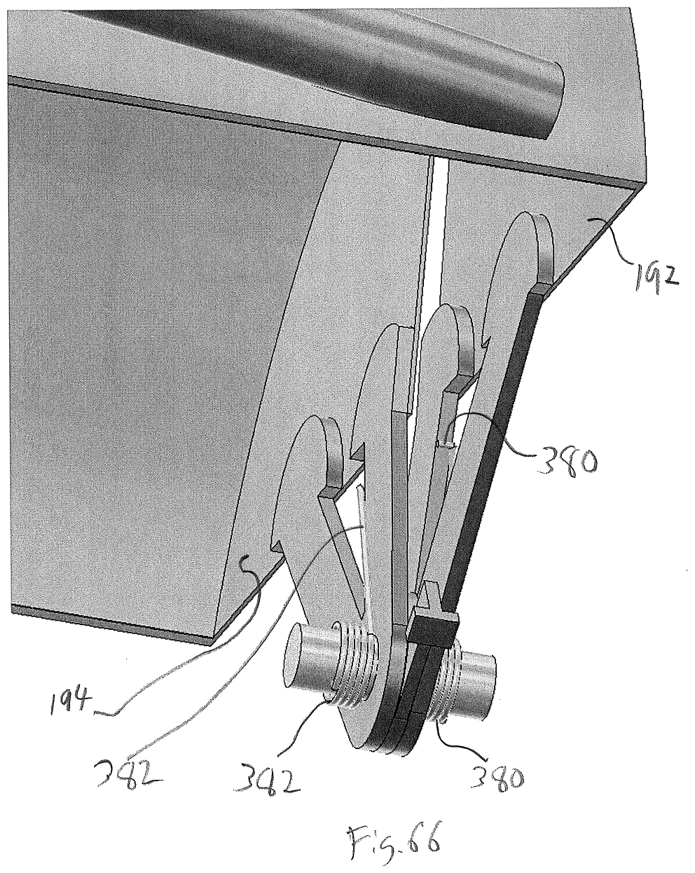

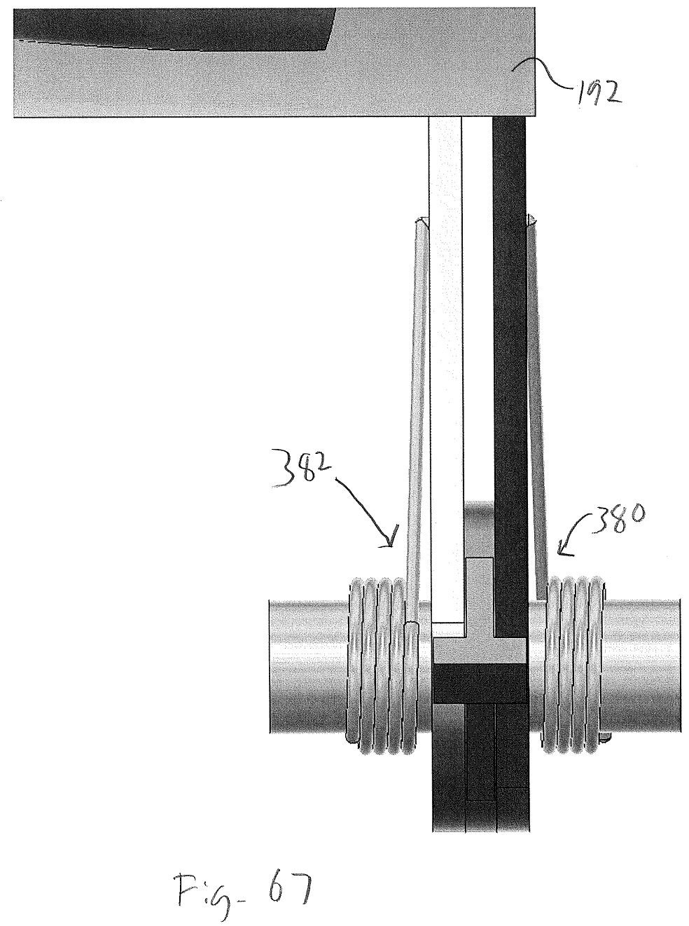

Turning now to the embodiments depicted in FIGS. 64 to 67, springs can be employed to assist in the opening and closing of the front lid portion (first lid portion) 192 and the rear lid portion (second lid portion) 194. For example, in an embodiment, a front lid torsion spring 380 is engaged with the front lid portion 192, and a rear lid torsion spring 382 is engaged with the rear lid portion 194. In an embodiment, the front lid spring 380 biases the weight of front lid portion 192 towards the open position, and the rear lid spring 382 biases the weight of the rear lid portion 194 towards the closed position.

In an embodiment, the force exerted on the rear lid portion 194 by the rear lid spring 382 is sufficient to move the rear lid from the rear lid's fully open position to the rear lid's fully closed position, as the front lid portion 192 is moved from the front lid's fully open position to the front lid's intermediate position (the front lid is depicted in its intermediate position, for example, in FIGS. 12 and 18). In an embodiment, when the front lid portion 192 is in the closed position (the front lid portion is depicted in the closed position, for example, in FIGS. 11 and 19), the front lid spring 380 is not sufficient to move the front lid portion 192 from the closed position towards the intermediate position. An external force, such as a force supplied by a user, can move the front lid portion from the closed position towards the intermediate position, with a portion of the force needed to move the front lid portion from the closed position towards the intermediate position also being supplied by the front lid spring 380.

Turning now to the embodiments depicted in FIGS. 9 to 20, various views are shown depicting a griddle plate 24 moving between a cooking position and a stowed positon. The grill of these embodiments also includes a lid, which is divided into a first lid portion 192 and a second lid portion 194. The first lid portion and the second lid portion can telescope relative to each other as the lid is moved between an open position (e.g. FIG. 13) and a closed position (e.g. FIGS. 19 and 20). In an embodiment, rather than being a two part telescoping lid as in FIGS. 9 to 20, the lid can consist of three independently rotatable lid portions, thereby forming a triple telescoping lid.

The movement of the griddle plate in the embodiments of FIGS. 9 to 20 is similar to that of the embodiment of FIGS. 1 to 8. In the embodiment of FIGS. 9 to 20, rather than constant force springs, cooking apparatus is provided with a pair of gas springs 196 that are positioned in extendable rails 178, and that exert an upward force on the slides 47, and in turn on griddle plate 24.

In the embodiment depicted in FIG. 21, line 198 is an imaginary line that designates the plane of the grill grate surface. As shown in FIG. 21, the plane of the grill grate surface 198 is the imaginary plane corresponding to the top side of the grill grate surface. For example, the plane of the grill grate surface 198 can be thought of as an infinitely thin, flat sheet that rests directly on top of the grill grate surface, with the sheet extending horizontally outward in all horizontal directions.

Similarly, in the embodiment depicted in FIG. 22, line 200 is an imaginary line that designates the plane of the griddle plate surface. The plane of the griddle plate surface 200 is the imaginary plane corresponding to the top side of the griddle plate surface. For example, the plane of the griddle plate surface can be thought of as an infinitely thin, flat sheet that rests directly on top of the griddle plate surface, with the sheet extending horizontally outward in all horizontal directions.

In the embodiments depicted in FIGS. 28, a portion of the griddle plate 24 is lower than the plane of the grill grate surface. More particularly, in this embodiment, a majority of the griddle plate is lower than the plane of the grill grate surface. Still more particularly, in this embodiment, approximately 70% of the griddle plate is lower than the plane of the grill grate surface, and approximately 30% of the griddle plate is higher than the plane of the grill grate surface.

In an embodiment, a lift mechanism can include a scissor lift, hand crank, motor such as electric motor, spring, gas spring, torsion spring, tension spring, constant force spring, counterweight, counterbalance mechanism, pulley mechanism, hydraulics, or other force applying means, or a combination of two or more of the foregoing, to fully, partially, or approximately offset the weight of the griddle plate. In an embodiment, the lift mechanism can be a motorized lift mechanism, a manual lift mechanism, and/or a manual lift mechanism with counterbalance assist or spring assist.

In an embodiment, instead of or in addition to the griddle plate being moveable, the grill grate can be moveable between a first position (e.g. a cooking position) and a second position (e.g. a stowed position). In an embodiment, the grill grate can be moveable in any of the ways that the griddle plate can be moveable, and any of the components or features described herein, including any of the components or features described herein in connection with the griddle plate being moveable, or that are used in or associated with the movement of the griddle plate, can be applied to or used in connection with the grill grate.

In an embodiment, a stowed position can include a position in which the griddle plate is no longer positioned over, or no longer positioned substantially over, the cooking heat source of the cooking position. In an embodiment, a stowed positioned can include a positioned where the griddle plate is intended to be stored when the griddle plate is not in a position in which food items are cooked on or intended to be cooked on the surface of the griddle plate.

In still other embodiments, the lift mechanism can be configured such that the upward force exerted by the lift mechanism is variable. For example, the lift mechanism can be configured such that the upward force exerted by the lift mechanism is manually variable by a user. In other embodiments, the lift mechanism can be configured such that the upward force exerted by the lift mechanism varies automatically.

In an embodiment, the lift mechanism is connected to the griddle plate, such that the lift mechanism supports at least a portion of the weight of the griddle plate between the cooking position and the stowed position. In some embodiments, the lift mechanism's supporting of the weight of the griddle plate between the cooking position and the stowed position can include the lift mechanism supporting the weight of the griddle plate during the griddle plate's entire path of travel between the cooking position to the stowed position. In other embodiments, the lift mechanism's supporting of the weight of the griddle plate between the cooking position and the stowed position can include the lift mechanism supporting the weight of the griddle plate during only a portion of the griddle plate's path of travel between the cooking position to the stowed position. For example, in an embodiment, the weight of the griddle plate can be partially or fully supported by structures such as the grill body, external support structures, and/or other structures when the griddle plate is in the cooking position (e.g. a raised and retracted position) and/or stowed position (e.g. lowered and retracted). In another embodiment, the weight of the griddle plate can be partially or fully supported by structures such as the grill body, external support structures, and/or other structures when the griddle plate is moving along the horizontal (e.g. with respect to the Earth's surface, or perpendicular to the direction of gravity) portions of its travel path between the cooking position and the stowed position, and the weight of the griddle plate can be partially or fully supported by the lift mechanism when the griddle plate is moving along the vertical portions of its travel path between the cooking position and the stowed position.

In some embodiments, due to the travel paths of the lid and/or griddle and associated slides, the structural connection points for supporting the weight of the grill body and/or griddle plate and associated lift mechanism can be limited. However, in an embodiment, the grill body can be a separate, independent structure from the griddle plate and associated lift mechanism, with no structural connections between the grill body and the griddle plate and associated lift mechanism. In such an arrangement, the structural connections for supporting the grill body would not need to provide support for the griddle plate and associated lift mechanism, and the structural connections for supporting the griddle plate and associated lift mechanism would not need to provide support for the grill body. In such an embodiment, since, for example, the structural connections for supporting the grill body would not need to provide support for the griddle plate and associated lift mechanism (including when the griddle plate is in both the extended position and the retracted position), the structural connections for supporting the grill body can be smaller and/or fewer in number, and with the locations of the structural connections being more flexible. For example, in an embodiment, structural support for the grill body can be provided at just two points, namely: 1) through the center of rotation about which the lid pivots are attached to the left side of the grill body; and 2) through the center of rotation about which the lid pivots are attached to the right side of the grill body. Since in this embodiment the structural supports for the grill body do not also need to account for the rotational force exerted by the griddle plate and associated lift mechanism (particularly when the griddle plate is in the extended position), the two single structural connections through the center of rotation about which the lid pivots can be sufficient to adequately support the grill body.

Also, in this embodiment, since the structural connections for supporting the lift mechanism and connected griddle plate do not need to also support the grill body, the structural connections for supporting the lift mechanism and connected griddle plate can be smaller and/or fewer in number, and with the locations of the structural connections being more flexible. For example, the lift mechanism can be supported at all points from the bottom, since in this embodiment the griddle plate remains over the lift mechanism legs at all times, and the griddle plate does not slice through the plane beneath the lift mechanism legs. In some embodiments in which a retractable lid is present, the lift mechanism can be supported at points from the bottom that are forward of the lid when the lid is in the retracted position.

In some embodiments, there are structural connections between the grill body and the griddle plate and associated lift mechanism, such that one or more structural connections can provide structural support for both the grill body and the griddle plate and associated lift mechanism.

In some embodiments, supporting the grill body (e.g. the weight of the grill body) from the sides, and, for example, near the front of the grill body, may be problematic as a support structure that is permanently or fixedly attached to the side of the grill body and that extends out to an external support structure (e.g. a grill cart or the counter of an outdoor kitchen) would block the vertical travel path of the griddle slides as the griddle plate is moved from the raised position to the lowered position (and vice versa), and therefore would prevent the griddle plate from being moved from the raised position to a lowered position (and vice versa). In those embodiments where this may occur, multiple solutions can be employed that can allow the grill body to be supported form the sides, and without blocking the vertical travel path of the griddle slides.

In an embodiment, an engageable and disengageable grill body support, such as a C-shaped simultaneously engageable and disengageable grill body support, can be employed. The C-shaped simultaneously engageable and disengageable grill body support can have an upper arm and a lower arm, and can be operated (i.e. the upper arm moving into an engaged position in which the grill body is supported by the upper arm, while lower arm is simultaneously moving into a disengaged position in which the grill body is not supported by the lower arm, and vice versa) by motor, manual methods, (e.g. by the user pushing a lever or moving a slide), or can be caused to operate as a result of the lift mechanism and/or griddle plate and/or associated structure moving from a raised position to a lowered position, and vice versa). For example, when the lift mechanism is moved from a raised position towards a lowered position, the lift mechanism can come into contact with a structure attached to the C-shaped grill body support, which, as the lift mechanism continues to move further towards a lowered position, causes the upper arm of the C-shaped grill body support to move into an engaged position, and simultaneously causes the lower arm of the C-shaped grill body support to move into a disengaged position. When the lift mechanism is moved from a lowered position towards a raised position, the foregoing movement of the C-shaped grill body support is reversed. Such movement of the C-shaped grill body support as the lift mechanism is moved from a raised position towards a lowered position, and from a lowered position towards a raised position, allows the grill body to be supported at all times by at least one of the upper arm of the C-shaped grill body support and the lower arm of the C-shaped grill body support, while at the same time allowing the griddle rails to be moved from the raised position to the lowered position, and vice versa, without the raised to lowered movement, or vice versa, being stopped as a result of the griddle rails coming into contact with the upper and/or lower arm of the C-shaped grill body support.

For example, an embodiment can have an upper front grill body support and a lower front grill body support, wherein when the griddle is moved from the raised position to the lowered position, the lower front grill body support is moved from an engaged (i.e. supporting the weight of the grill body) position to a disengaged position, and the upper front grill body support is moved from a disengaged positon to an engaged position, and wherein the transition from the lower front grill body support being engaged to the upper front grill body support being engaged occurs when the vertical positioning of the griddle is located in between the upper front grill body support and the lower front grill body support. In an embodiment, the movements described in the foregoing between engaged and disengaged are reversed when the griddle plate is moved from the lowered position to the raised position. In an embodiment, the movement of the griddle plate and/or associated structures provides the force for the above engagements and disengagements.

In an embodiment, there is a wedged shaped front grill body support that is manually engaged and disengaged by the user, such that the front grill body support is disengaged when the griddle is moved between the raised position and the lowered position, and then reengaged by the user when the griddle is in the raised position or lowered position as applicable, with the front grill body support being wedge shaped so that any sag in the grill body when it is in the disengaged position, can be removed by the wedge pushing the grill body back up when the front grill body support is reengaged.

In an embodiment, grill body supports can be provided that fold down when the griddle plate contacts the grill body supports as the griddle plate is retracted beneath grill in the stowed position, and that pop up from the bottom or pop out from the sides (e.g. by being spring loaded or spring biased into the popped up or popped out position) when the griddle plate is extended. In the popped up or popped out position, the weight of the grill body can be supported by the grill body support. When the griddle is retracted beneath the grill, the top of the griddle sides, the top of the slides, or other structures associated with the griddle plate can contact rollers that are connected to bottom of grill body, and can thereby support the weight of the grill body.

Referring again to the embodiments depicted in FIGS. 9 to 20, in an embodiment, covers 202, for example hinged flaps, can be used to cover or seal openings in or adjacent to the front of the grill body and/or openings in or adjacent to the top of the grill body that allow the extendable rails, lift mechanism, or other structures associated with the movement of the griddle plate, to move between the cooking position and the stowed position. For example, when the griddle plate is moving between the cooking position and the stowed position, the movement of the griddle plate can force the flaps to open and uncover the openings, such that the flaps do not interfere with the path of travel of the extendable rails, lift mechanism, or other structures. Once the extendable rails, lift mechanism, or other structures have cleared the openings, the flaps can close to cover or seal the openings.

In an embodiment, for example the embodiments depicted in FIGS. 9 to 20, the lid is split into two parts, namely a front lid portion and a rear lid portion (or a first lid portion and a second lid portion), counterbalance(s) can be used on the front and/or the rear lid, springs can be used on the front and/or rear lid, or a combination of counterbalance(s) and spring(s) can be used on the front lid and rear lid. In an embodiment, the counterbalance for the lid, the front lid, and/or the rear lid can be a simple counter weight (e.g. a mass), that is positioned opposite the mass of the lid (or rear lid or front lid). In another embodiment, the counterbalance force for the lid can be provided by springs, constant force springs, gas springs, or any other force inducing mechanism or counterbalancing mechanism, including but not limited to any other force inducing mechanism or counterbalancing mechanism described herein or described elsewhere in connection with the griddle plate.

In an embodiment, when first raising (i.e. opening) the lid, initially only the front lid moves (i.e. rotates rearward and backward), until the front lip of the front lid is essentially flush with the front lip of the rear lid. At this point, a stop 204, such as a lever, or other device that is tied to the motion of the front lid, comes into contact with a corresponding stop, lever, or other device that is tied to the motion of the rear lid. At this point, the rear lid can be either biased or frictioned towards the lid closed position, so that a discernable stop or resistance is felt by a user (thus creating a natural resting position where the user can position the lid) when the lever of the front lid contacts the lever of the rear lid (i.e. when the overall lid is at its half open position, i.e. the point at which the front lip of the front lid is essentially flush with the front lip of the rear lid). This results in a natural stopping point for a user opening the lid, which corresponds to the lid being in the approximately half open position. If at this point the user applies additional force towards opening the lid, the biasing (or friction) force of the rear lid will be overcome, and both the front and rear lid will continue to rotate backwards and downwards together, with the rotation of the rear lid being caused by the contact with the lever of the front lid. In an embodiment, the rear lid is biased toward the closed position, so that if at any point between the half open position of the lid and the fully open position, if the user returns the front lid to the closed position, the biasing force of the rear lid will also cause the rear lid to return to the closed position. However, if the front lid and rear lid are moved all the way to the fully open position, the lids can remain in that fully open position without any force being applied by a user. Once a user grasps the front lid and rotates it towards the closed position, the rear lid can rotate with the front lid until the rear lid reaches its fully closed position, at which point the front lid can continue to rotate by itself until it also reaches its fully closed position. In an embodiment, the force to rotate the rear lid toward its closed position as the front lid is being rotated toward its closed positon can be provided by a spring 204, counterbalance, or other force providing mechanism.

In an embodiment, the rear lid can include a simple spring which biases the rear lid towards the closed position, and the front lid can include a counterbalance mechanism which allows the front lid to remain stationary at any rotational position along the rotational path of the front lid between the fully open position of the front lid to the half open (i.e. flush with the rear lid) position of the front lid.

In an embodiment, the rear lid can include a spring mechanism, and the front lid can include neither a spring nor a counterbalance mechanism. In another embodiment, neither the front lid nor the rear lid can include either a spring or a counterbalance mechanism. In yet another embodiment, the front lid can include a spring and/or counterbalance, and/or the rear lid can include a spring and/or a counterbalance.

In another embodiment, a stop, retainer, or other device can be used to maintain the front and/or rear lid in the fully open position, the fully closed position, or any intermediate position.

In another embodiment, both the front and the rear lid can include counterbalance mechanisms, which allow the front lid to be stopped and remain stationary at any rotational position along the rotational path of the front lid, the rear lid (along with the flush positioned front lid) to be stopped and remain stationary at any rotational position along the rotational path of the rear lid, with also a discernable stop that can be felt by a user as the front lip of the front lid first comes flush with the front lip of the rear lid.

In other embodiments, another stop, lever or other device tied to the rotation of the front lid can come into contact with another corresponding stop, lever or other device tied to the rotation of the rear lid, such that when the front lid is rotated towards the closed position, the front lid will pull/drag the rear lid with it until the rear lid reaches its fully closed position.

In another embodiment, the weight of the rear lid can be naturally biased towards the fully open position (i.e. with no other force being present other than the weight of the lid, the lid would rotate towards the fully open position). In contrast, the weight of the front lid can be naturally biased towards the fully closed position. A tab or other stop at the rear lip of the front lid can engage a corresponding tab or stop at the front lip of the rear lid, so that when both the front lid and the rear lid are in the fully closed position, the rear lid's natural tendency to rotate towards its open position is prevented from doing so by the tab of the rear lid engaging with the tab of the front lid. For example, in this embodiment, the front lid weighs slightly more than the rear lid (due to: 1) the front lid being slightly larger than the rear lid since the front lid is the outer lid; and 2) the handle that is attached to the front lid), so that when both the front lid and the rear lid are in the fully open position, the extra weight of the front lid keeps both the front lid and the rear lid in the fully closed position, until a user applies an opening force to the front lid. In such an embodiment, when a user begins to lift the front lid, both the front lid and the rear lid would rotate towards the open position. Once the front lid reaches its mid position (i.e. the half open position of the overall lid), the rear lid would now be in its fully open position. As the user continues to rotate the front lid from the mid position to the fully open position, only the front lid would be rotating (since the rear lid would have already reached the fully open position). Next, if a user wants to move the overall lid from the fully open position towards the closed position, the movement is essentially reversed, so that at first only the front lid rotates towards the closed position until it reaches the mid position. At the mid position, the tab of the front lid contacts the tab of the rear lid, and as the front lid continues to move from the mid position towards the fully closed position, the front lid pulls or drags the rear lid with it (via the engagement of the corresponding tabs), so that the rear lid rotates from its fully open position toward its fully closed position.

In an embodiment, a rear griddle plate support can be provided. In an embodiment, the rear griddle plate support can be connected to the grill body or other support structure, and contact the rear of the griddle plate and thereby provide support for the weight of the griddle plate. In an embodiment, the rear griddle plate support can include a roller at its upper end or can include a wedge at its upper end, in order to assist the support of the griddle plate as the griddle plate is moved from an extended position to a retracted position.

In an embodiment, the lid's tendency to rotate between the closed position and open position due to the weight of the lid can be counterbalanced by a counterbalance mechanism, weights, a coiled spring, a gas spring, or other means or any combination thereof, including any other means disclosed herein in connection with lift mechanisms and counterbalance mechanisms. The joint around which the lid revolves can also contain a bushing, friction inducing member, or other motion resistance member which can resist the rotational motion of the lid, and can cause the lid to remain fixed at whatever rotational position the rotation of the lid is stopped at, until such time as sufficient rotational force is applied, for example by a user, to overcome the motion resistance member.

In an embodiment, lift mechanisms, counterbalance mechanisms, movement mechanisms, and other mechanisms described herein can be used for applications other than outdoor grills. For example, the mechanisms disclosed herein can be utilized in sit-stand desks, height adjustable tables, height adjustable work surfaces, indoor griddle grills (e.g. indoor cooktops, indoor rangetops, indoor stoves, etc. with a moveable griddle feature), pull out and pull down shelves and drawers, reconfigurable/height adjustable filing cabinet systems (or drawer systems or shelf systems), height adjustable pull out keyboard shelves, height adjustable pull out oven racks (that can allow a user to easily adjust the height of the oven rack), office desks (or other work surfaces) with a secondary/auxiliary pull out height adjustable work surface, etc.

In an embodiment, counterbalance movement mechanisms of the types described herein (e.g. the counterbalanced slide mechanism for the griddle plate) can be used in indoor kitchen environments, such as commercial and residential indoor kitchens. In an embodiment, the counterbalance movement mechanism is used in conjunction with an indoor cooktop, rangetop, or range to move a first cooking surface between a position above a cooking heat source in which food items are cooked, and a position below the cooking heat source in which the first cooking surface is stored. For example, an indoor cooktop can include a cooking heat source, such as gas or electric burners. The cooktop can include a second cooking surface, which can be grate or other structure on which food items are directly or indirectly placed in order to heat and/or cook the food. In an embodiment, the second cooking surface can be a grate (above the burner) on which pots, pans, and other cooking implements may be placed in order to heat and/or cook food.

For example, an embodiment is an indoor cooktop which includes a conventional cooking surface (e.g. a first cooking surface). The embodiment also includes a counterbalance movement mechanism which can be used to move a second cooking surface (e.g. a griddle plate) between a position above the first cooking surface in which food items are cooked, and a stowed position (e.g. below the first cooking surface).

In an embodiment, the lid is connected to the grill body, and the base of the lift mechanism is located outside of the left and right edges of the lid at the bottom, but the mechanism is narrowed or jutted inward moving upward towards the mechanism's attachment with the griddle plate, such that the base of the mechanism falls outside of the edges of the lid, and the griddle plate and slides fall within the outside edges of the lid when the griddle plate is raised and the lid is in the closed position. In an embodiment, the outer edges of the lid can flare out on the front half of the lid, but not the rear of the lid, thus allowing the lid to cover a two-way slide when in the closed position, yet not interfere with the supporting of the lift mechanism base when the lid is in the open position.

In the embodiment depicted in FIG. 23a, the griddle plate 24 is in a retracted position, and the footprint (in a vertical direction relative to the Earth's surface or with respect to the direction of gravity) of the griddle plate 24 is partially within the footprint of the grill grate 18. In contrast, in the embodiment depicted in FIGS. 15a to 15d, the griddle plate 24 is in an extended position, and the footprint of the griddle plate 24 is outside of the footprint of the grill grate 18. In the embodiment depicted in FIGS. 14a to 14d, the griddle plate 24 and lift mechanism 30 are also in a raised position. In an embodiment, the grill grate 18 and/or griddle plate 24 can include an integrated temperature probe.

In an embodiment, the lift mechanism can include an articulated arm, for example an articulated arm that counterbalances the griddle plate, and that is capable of moving the griddle plate between a cooking position and a stowed position. As used herein, mechanically counterbalancing the weight (or a portion of the weight) of the griddle plate, means counterbalancing the weight (or a portion of the weight) of the griddle plate with a non-human means, such as with a counterbalance mechanism.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

I claim:

1. A cooking apparatus comprising:
a) a cooking heat source;
b) a grill grate having a grill grate surface, said grill grate surface defining a plane of said grill grate surface, said grill grate being positioned over said cooking heat source;
c) a griddle plate, said griddle plate being moveable between a cooking position and a stowed position, said griddle plate being positioned over said grill grate in said cooking position, and a majority of said griddle plate being lower than said plane of said grill grate surface in said stowed position;
d) a counterbalance mechanism connected to said griddle plate;
e) a support frame connected to said griddle plate;
f) a first slot extending vertically through said support frame;
g) a first lid, said first lid having a first lid open position and a first lid closed position, wherein a first portion of said first lid extends through said first slot when said first lid is in said first lid open position, and said first portion of said first lid does not extend though said first slot when said first lid is in said first lid closed position;
h) a second slot extending vertically through said support frame; wherein a second portion of said first lid extends through said second slot when said first lid is in said first lid open position, and said second portion of said first lid does not extend though said second slot when said first lid is in said first lid closed position;
i) a second lid, said second lid having a second lid open position and a second lid closed position, wherein a first portion of said second lid extends through said first slot when said second lid is in said second lid open position, and said first portion of said second lid does not extend though said first slot when said second lid is in said second lid closed position, and wherein a second portion of said second lid extends through said second slot when said second lid is in said second lid open position, and said second portion of said second lid does not extend though said second slot when said second lid is in said second lid closed position; and
j) a first torsion spring and a second torsion spring, wherein said first torsion spring biases said first lid towards said first lid open position, and said second torsion spring biases said second lid towards said second lid closed position.

2. The cooking apparatus of claim 1 further comprising a roller slidably engaged with said griddle plate, wherein said roller biases said griddle plate in a direction away from said grill grate during a vertical movement of said griddle plate.

3. The cooking apparatus of claim 1, wherein said griddle plate is biased in a direction away from said grill grate.

4. The cooking apparatus of claim 1, wherein said cooking apparatus is installed in a kitchen counter.

5. A cooking apparatus comprising:
a) a cooking heat source;
b) a grill grate having a grill grate surface, said grill grate surface defining a plane of said grill grate surface, said grill grate being positioned over said cooking heat source;
c) a griddle plate, said griddle plate being moveable between a cooking position and a stowed position, said griddle plate being positioned over said grill grate in said cooking position, and a majority of said griddle plate being lower than said plane of said grill grate surface in said stowed position;
d) a counterbalance mechanism connected to said griddle plate;
e) a support frame connected to said griddle plate;
f) a first slot extending vertically through said support frame; and
g) a first lid, said first lid having a first lid open position and a first lid closed position, wherein a first portion of said first lid extends through said first slot when said first lid is in said first lid open position, and said first portion of said first lid does not extend though said first slot when said first lid is in said first lid closed position.

6. The cooking apparatus of claim 5 further comprising a second slot extending vertically through said support frame; wherein a second portion of said first lid extends through said second slot when said first lid is in said first lid open position, and said second portion of said first lid does not extend though said second slot when said first lid is in said first lid closed position.

7. The cooking apparatus of claim 6 further comprising a second lid, said second lid having a second lid open position and a second lid closed position, wherein a first portion of said second lid extends through said first slot when said second lid is in said second lid open position, and said first portion of said second lid does not extend though said first slot when said second lid is in said second lid closed position.

8. The cooking apparatus of claim 7, wherein a second portion of said second lid extends through said second slot when said second lid is in said second lid open position, and said second portion of said second lid does not extend though said second slot when said second lid is in said second lid closed position.

9. The cooking apparatus of claim 5 further comprising:
a) a second lid, said second lid having a second lid open position and a second lid closed position; and
b) a first spring and a second spring, wherein said first spring biases said first lid towards said first lid open position, and said second spring biases said second lid towards said second lid closed position.

10. The cooking apparatus of claim 9, wherein said first spring is a torsion spring and said second spring is a torsion spring.

11. The cooking apparatus of claim 5 further comprising a second lid, said second lid having a second lid open position and a second lid closed position, wherein said second lid is biased towards said second lid closed position, and said first lid is biased towards said first lid open position.

12. The cooking apparatus of claim 5, wherein said first lid is biased towards said first lid open position.

13. The cooking apparatus of claim 5 further comprising a first spring, wherein said first spring biases said first lid towards said first lid open position.

14. The cooking apparatus of claim 5 further comprising a second lid, said second lid having a second lid open position and a second lid closed position, wherein said second lid is biased towards said second lid closed position.

15. The cooking apparatus of claim 5 further comprising:
a) a spring; and
b) a second lid, said second lid having a second lid open position and a second lid closed position, wherein said spring biases said second lid towards said second lid closed position.

16. The cooking apparatus of claim 5 further comprising a roller slidably engaged with said griddle plate, wherein said roller biases said griddle plate in a direction away from said grill grate during a vertical movement of said griddle plate.

17. The cooking apparatus of claim 5, wherein said griddle plate is biased in a direction away from said grill grate.

18. The cooking apparatus of claim 5, wherein said cooking apparatus is installed in a kitchen counter.

19. A method of modifying a cooking apparatus comprising:
a) positioning a grill grate between a cooking heat source and a griddle plate;
b) exposing at least a portion of the grill grate for cooking by moving the griddle plate;
c) moving at least a portion of the griddle plate vertically;
d) mechanically counterbalancing at least a portion of the weight of the griddle plate during at least a portion of said moving at least a portion of the griddle plate vertically;
e) moving a first lid from a closed position to an open position;
f) extending a first portion of the first lid through a first slot in a support frame during said moving a first lid from a closed position to an open position;
g) extending a second portion of the first lid through a second slot in the support from during said moving a first lid from a closed position to an open position;
h) moving a second lid from a closed position to an open position;
i) extending a first portion of the second lid through the first slot in the support frame during said moving a second lid from a closed position to an open position;
j) extending a second portion of the second lid through a second slot in the support from during said moving a second lid from a closed position to an open position;
k) biasing the first lid towards an open position; and
l) biasing the second lid towards a closed position.

20. The method of modifying a cooking apparatus of claim 20, further comprising installing the cooking apparatus in a kitchen counter.
